(19) United States
(12) Patent Application Publication
(10) Pub. No.: US 2009/0036297 A1
(43) Pub. Date: Feb. 5, 2009

(54) Sol Gel Functionalized Silicate Catalyst and Scavenger

(75) Inventors: Cathleen M. Crudden, Kingston (CA); Mutyala Sateesh, Hyderabad (IN); Alexandre Blanc, Montpellier (FR)

Correspondence Address: Ralph A. Dowell of DOWELL & DOWELL P.C., 2111 Eisenhower Ave, Suite 406, Alexandria, VA, 22314, US

(73) Assignee: QUEEN'S UNIVERSITY AT KINGSTON, Kingston (CA)

(21) Appl. No.: 11/885,672

(22) PCT Filed: Mar. 7, 2006
(86) PCT No.: PCT/CA2006/000332

§ 371 Date: Jun. 23, 2008

Related U.S. Application Data
(60) Provisional application No. 60/658,579, filed on Mar. 7, 2005.

(30) Foreign Application Priority Data
Mar. 7, 2005 (CA) 2,499,782

(51) Int. Cl. B01J 31/02

(52) U.S. Cl. 502/158

(57) ABSTRACT

This invention relates to materials suitable as metal scavengers and catalysts. The materials are prepared by functionalizing silicate materials such as silica or SBA-15 with a thiol or amine, or other functionalizing agent, in a sol gel process. In a preferred embodiment, the metal is palladium and the functionalizing agent is a thiol. The material may be used as a catalyst for the Suzuki-Miyaura and Mizoroki-Heck coupling reactions. The catalyst materials have extremely low metal leaching, are very stable, and are completely recyclable.

### RELATED APPLICATIONS

This application claims the benefit of the filing date of U.S. Patent Application No. 60/658,579, filed on Mar. 7, 2005, the contents of which are incorporated herein by reference in their entirety.

### FIELD OF THE INVENTION

This invention relates to metallic catalysts and scavengers for removing metals from aqueous and organic solutions. More particularly, this invention relates to metallic catalysts based on functionalized solid phase supports prepared by a sol gel method.

### BACKGROUND OF THE INVENTION

Metal-catalyzed reactions have become part of the standard repertoire of the synthetic organic chemist (Diederich et al. 1998). For example, palladium catalysts are used for coupling reactions like the Mizoroki-Heck reaction and the Suzuki-Miyaura reaction, and provide one step methods for assembling complex structures such as are found in pharmaceutical products. These reactions are also used for the preparation of highly conjugated materials for use in organic electronic devices (Nielsen 2005). In addition, metals such as rhodium, iridium, ruthenium, copper, nickel, platinum, and particularly palladium are used as catalysts for hydrogenation and debenzylation reactions. Despite the remarkable utility of such metal catalysts, they suffer from a significant drawback, namely that they often remain in the organic product at the end of the reaction, even in the case of heterogeneous catalysts (for palladium, see, for example, Garret et al. 2004, Rosso et al. 1997, Königsberger et al. 2003). This is a serious problem in the pharmaceutical industry since the level of heavy metals such as palladium in active pharmaceutical ingredients is closely regulated. Metal contamination can also be an issue in commodity chemicals such as flavours, cosmetics, fragrances, and agricultural chemicals that are prepared using metallic catalysis.

Attempts to improve the reusability of palladium and prevent contamination of organic products by stabilizing it on a solid support such as silica (Mehhert et al. 1998, Bedford et al. 2001, Nowotny et al. 2000) or by immobilizing it in another phase in which the product is not soluble (Rockaboy, 2003) have been made. However, the majority of these approaches were found to be unsatisfactory because of poor recycling ability and/or instability which resulted in considerable leaching of palladium into solution. In many cases, heterogeneity tests showed that the supported catalyst was merely a reservoir for highly active soluble forms of Pd, or Pd nanoparticles (Rockaboy et al. 2003, Nowotny et al. 2000, Davies et al. 2001, Lipshutz et al. 2003). Recently, better results have been obtained by grafting a palladium layer onto mesoporous silicates such as SBA-15 (Li et al. 2004) or FSM-16 (Shimizu et al. 2004), or by incorporating palladium into the silicate material during synthesis (Hamza et al. 2004).

Various methods have been proposed for separating metals from reaction mixtures. For example, palladium can be precipitated from solution using 2,4,6-trimercapto-5-triazine (TMT) (Rosso et al. 1997), removed using acid extraction (e.g., lactic acid, Chen et al. 2003) or charcoal treatment (Prasad 2001), or the product can be precipitated while leaving palladium in solution (Konigsberger et al. 2003). However, such methods may be unable to remove the metal to the extent required for regulatory approval, they may add further reaction steps to the manufacturing process (Garrett 2004), or they may result in significant losses of product such that the process is not economically viable.

In the area of environmental remediation, separation of metals, particularly heavy metals such as mercury, is also an issue. Functionalized silicates, are effective at removing metals like mercury from wastewater streams. The effectiveness of such materials is believed to stem from their high porosity, which permits access of the contaminant to the ligand. For example, Pinnavaia and Fryxell have independently shown that mercaptopropyl trimethoxy silane modified mesoporous materials are effective adsorbents for mercury (Feng 1997, Mercier 1997).

### SUMMARY OF THE INVENTION

According to one aspect of the invention there is provided a catalyst comprising a functionalized silicate material and a metal, said catalyst prepared by a method comprising:

synthesizing the functionalized silicate material by one-step co-condensation of a silicate of form SiA₄ and a proportion of a functionalizing agent that is a ligand for the metal, where each A is independently selected from:

R, or a hydrolyzable group;

wherein R is H or an organic group selected from:
alkyl, which may be straight chain, branched, or cyclic, substituted or unsubstituted, C₁ to C₄ alkyl;
aryl or heteroaryl, both of which may be substituted or unsubstituted;
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and

wherein the hydrolyzable group is selected from OR, halogen phosphate, phosphate ester, alkoxycarbonyl, hydroxyl, sulfate, and sulfonato;
where R is as defined above;

filtering and drying the functionalized silicate material;

combining the functionalized silicate material with a mixture of one or more metals and dry solvent; and

filtering the mixture to obtain the catalyst.

In one embodiment, the silicate is of the form (RO)_{4-q}Si-A_{q}, where each RO and A are as defined above, but RO and A are not the same, and q is an integer from 1 to 3.

In another embodiment the silicate is tetraethoxysilane (TEOS).

In another embodiment the silicate is a silsesquioxane.

In another embodiment the siloxane is of the formula (RO)₃Si—R′—Si(OR)₃, where R is as defined above and R′ is a bridging group selected from alkyl and aryl. In various embodiments the bridging group is selected from methylene, ethylene, propylene, ethenylene, phenylene, biphenylene, heterocyclyl, biarylene, heteroarylene, polycyclicaromatic hydrocarbon, polycyclic heteroaromatic and heteroaromatic. In a preferred embodiment the bridging group is 1,4-phenyl and the silicate is 1,4-disiloxyl benzene.

In another embodiment the method further comprises adding a structure-directing agent (SDA) during the condensation to introduce porosity to the silicate material; and removing the SDA by extraction before combining the silicate material with the metal.

In another embodiment the method further comprises providing the metal as a pre-ligated complex, where the pre-ligated complex may be of the general formula AₘM[Q-(CH₂)ₙ—Si(OR)₃]ᵣ₋ₘ, where A and R are as defined above, Q is a functional group, M is the metal, r is the coordination number of the metal, m is an integer from 0 to r, and n is an integer from 0 to 12.

In other embodiments the method further comprises providing the metal as a salt or as preformed nanoparticles. The method may further comprise protecting the metal nanoparticles with a trialkoxysilane-modified ligand.

In another embodiment the trialkoxysilane-modified ligand (i.e., the functionalizing agent) is of the form [Q-(CH₂)ₚ—Si(OR)₃], where Q is the functional group, R is as set forth above, and p is an integer from 1 to 12.

In another embodiment the metal is selected from palladium, platinum, rhodium, iridium, ruthenium, osmium, nickel, cobalt, copper, iron, silver, and gold, and combinations thereof. In a preferred embodiment the metal is palladium.

In another embodiment the functionalizing agent is selected from thiol, disulfide amine, diamine, triamine, imidazole, phosphine, pyridine, thiourea, quinoline, and combinations thereof.

In another embodiment the silicate material is a mesoporous silicate material.

In another embodiment the silicate material is selected from SBA-15, FSM-16, and MCM-41.

In another embodiment the silicate material is SBA-15.

The invention also provides a method of catalyzing a chemical reaction comprising providing to the reaction a catalyst as described above. The chemical reaction may be a coupling reaction selected from Mizoroki-Heck, Suzuki-Miyaura, Stille, Kumada, Negishi, Sonogashira, Buchwald-Hartwig, and Hiyama reactions. In other embodiments, the chemical reaction may be selected from hydrosilylation, hydrogenation reactions and debenzylation reactions.

The invention also provides a method of preparing a catalyst comprising a functionalized silicate material and a metal, said method comprising:

synthesizing the functionalized silicate material by one-step co-condensation of a silicate of form SiA₄ and a proportion of a functionalizing agent that is a ligand for the metal, where each A is independently selected from:

R, or a hydrolyzable group;

wherein R is H or an organic group selected from:
alkyl, which may be straight chain, branched, or cyclic, substituted or unsubstituted, C₁ to C₄ alkyl;
aryl or heteroaryl, both of which may be substituted or unsubstituted;
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and

wherein the hydrolyzable group is selected from OR, halogen phosphate, phosphate ester, alkoxycarbonyl, hydroxyl, sulfate, and sulfonato;
where R is as defined above;

filtering and drying the functionalized silicate material;

combining the functionalized silicate material with a mixture of one or more metals and dry solvent; and

filtering the mixture to obtain the catalyst.

The invention also provides a method of scavenging one or more metals from a solution, comprising:

providing a scavenger comprising a functionalized silicate material; and

combining the functionalized silicate material with the solution such that the one or more metals is captured by the scavenger;

wherein the scavenger is prepared by a method comprising:

synthesizing the functionalized silicate material by one-step co-condensation of a silicate of form SiA₄ and a proportion of a functionalizing agent that is a ligand for the metal, where each A is independently selected from:

R, or a hydrolyzable group;

wherein R is H or an organic group selected from:
alkyl, which may be straight chain, branched, or cyclic, substituted or unsubstituted, C₁ to C₄ alkyl;
aryl or heteroaryl, both of which may be substituted or unsubstituted;
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and

wherein the hydrolyzable group is selected from OR, halogen phosphate, phosphate ester, alkoxycarbonyl, hydroxyl, sulfate, and sulfonato;
where R is as defined above;

filtering and drying the functionalized silicate material.

According to another aspect of the invention there is provided a catalyst comprising a functionalized silicate material and a metal, said catalyst prepared by a method comprising:

synthesizing the functionalized silicate material by one-step co-condensation of a silicate precursor and a proportion of a functionalizing agent that is a ligand for the metal, wherein the silicate precursor is selected from:
(1) SiG₄₋ₐXₐ, where a is an integer from 2 to 4;
   G is an organic group selected from but not limited to:
   alkyl having from 1 to 20 carbon atoms, which may be straight chain, branched, or cyclic, substituted or unsubstituted;
   alkenyl having from 1 to 20 carbon atoms, which may be straight chain, branched, or cyclic, substituted or unsubstituted;
   aryl or heteroaryl, which may be substituted or unsubstituted; and
   alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
   X is a group capable of undergoing condensation, selected from but not limited to: alkoxy (OG (where G is defined as above)), halogen, allyl, phosphate, phosphate ester, alkoxycarbonyl, hydroxyl, sulfate, and sulfonato;
(2) metal silicates such as sodium or the silicate; sodium meta silicate; sodium di silicate; or sodium tetra silicate;
(3) preformed silicates, such as kanemite;
(4a) organic/inorganic composite polymers such as silsesquioxanes of general structure E-R″-E, wherein:
   E is a polymerizable inorganic group such as a silica-based group, such as SiX₃, where X is defined as above; and
   R″ is selected from an aliphatic group such as —(CH₂)_{b}— where b is an integer from 1 to 20, which may be linear, branched, or cyclic, substituted or unsubstituted, and an unsaturated aliphatic group such as —(CH)_{b}— or —(C)_{b}—, including aromatic groups such as —(C₆H₄)_{b}— which may be substituted or unsubstituted;
(4b) organic/inorganic composite polymers such as polyalkylsiloxanes, polyarylsiloxanes, where the structure of the polymer is —[SiG₂O]_{z}— where G is as defined above and z is an integer from 10 to 200;
(5) a mixture of organic and inorganic polymers, for example a composite prepared by co-condensation between an inorganic silica precursor such as TEOS and a silsesequioxane precursor such as E-R″-E, or a co-condensation between TEOS and a siloxane terminated organic polymerizable group such as X₃Si—R″-Z, where Z is a polymerizable organic group such as an acrylate or styrene group, and E and R″ are defined as above, such as ORMOSIL type materials; and
(6) a pre-polymerized silicate based material with general formula SiO₂;

wherein the functionalizing agent is E-R″-Y, where E and R″ are as defined above and Y is a functional group comprising S, N, O, C, H, P, or a combination thereof;

filtering and drying the functionalized silicate material; and

combining the functionalized silicate material with a mixture of a dry solvent and one or more metals or complexes thereof selected from palladium, platinum, rhodium, iridium, ruthenium, osmium, nickel, cobalt, copper, iron, silver, and gold to obtain the catalyst.

The method may further comprise filtering the combination to obtain the catalyst.

In one embodiment, the silsesequioxane precursor is X₃Si—R″—SiX₃, where X and R″ are as defined above.

In one embodiment the metal is palladium.

In one embodiment, G is Me or Ph or a combination thereof.

In another embodiment, G is —(CH₂)₂— or —C₆H₄— or —C₆H₄—C₆H₄— or a combination thereof, and E is Si(OEt)₃ or Si(OMe)₃.

The functionalizing agent may be introduced in the form of X₃₋ₑGₑSi—R″-Y, where e is an integer between 0 and 2, R″, G, and X are defined as above and Y is a functional group based on any of the following elements: S, N, O, C, H, P, including, but not limited to: SH, NH₂, PO(OH)₂, NHCSNH₂, NHCONH₂, SG, NHG, PG₃, PO(OG)₂, NG₂, imidazole, benzimidazole, thiazole, POCH₂COG, crown ethers, aza or polyazamacrocycles and thia macrocycles.

In another embodiment, Y may be an aromatic group such as benzene, naphthalene, anthracene, pyrene, or an aliphatic group where Y is (—CH₂)_{b}—H where b is an integer from 1 to 20.

The method may further comprise adding a porogen or structure-directing agent (SDA) during the condensation to introduce porosity to the silicate material; and removing the SDA before combining the silicate material with the metal.

In one embodiment, the SDA is a non-ionic surfactant

In another embodiment, the SDA is a non-ionic surfactant selected from an aliphatic amine, dodecyl amine, and α-, β-, or γ-cyclodextrin.

In another embodiment, the SDA is a non-ionic polymeric surfactant such as Pluronic 123 (P123).

In another embodiment, the SDA is a combination of an ionic and a non-ionic surfactant.

In another embodiment, the SDA is a combination of a cationic and a non-ionic surfactant.

In another embodiment, the SDA is a combination of a cationic surfactant such as CTAB (cetyltrimethylammonium bromide) and a non-ionic surfactant such as C₁₆EO₁₀, (Brij5).

In a preferred embodiment, the SDA is a combination of an anionic surfactant and a non-ionic surfactant.

In a more preferred embodiment, the SDA is a combination of sodium dodecyl sulfate (SDS) and a polyether surfactant such as P123, F127, or a Brij-type surfactant.

In the most preferred embodiment, the SDA is a combination of SDS and P123.

In a further embodiment, the SDA is a combination of one or more surfactants and a pore expander.

In another embodiment the method further comprises providing the metal as an ionic or covalent complex or as a pre-ligated complex, where the pre-ligated complex may be of the general formula LₘM[Y—(CH₂)_{b}—SiX₃]ᵣ₋ₘ, where X is as defined above, Y is a functional group as defined above, M is the metal, r is the coordination number of the metal, L is a ligand for the metal, m is an integer from 0 to r, and b is an integer from 1 to 20.

The ligand for the metal may be ionic, such as a member of the class of compounds defined above as X, or non-ionic, wherein the non-ionic ligand is selected from P, S, O, N, C and H. For example, such ligands may include PG₃, SG₂, OG₂ or NG₃, where G is defined as above and may also be H.

In another embodiment the trialkoxysilane-modified ligand (i.e., the functionalizing agent) is of the form [Y—(CH₂)_{b}—SiX₃], where Y is a functional group as described above, and b is an integer from 1 to 20.

In another embodiment the functionalizing agent is selected from thiol, disulfide amine, diamine, triamine, imidazole, phosphine, pyridine, thiourea, quinoline, and combinations thereof.

In other embodiments the method may further comprise providing the metal as a salt, an ionic complex, a covalent complex, or as preformed nanoparticles. The method may further comprise protecting the metal nanoparticles with a trialkoxysilane-modified ligand.

The method may also comprise adsorbing the metal nanoparticles after their independent preparation in solutions containing stabilizers, for example surfactants, phase transfer catalysts, halide ions, carboxylic acids, alcohols, polymers.

In another embodiment, the nanoparticles may be prepared in an SDS solution prior to use of the SDS as the SDA for the silicate synthesis, or the nanoparticles may be introduced after the synthesis of the silicate material is complete

In another embodiment the silicate material is a mesoporous silicate material.

In another embodiment the silicate material is selected from SBA-15, FSM-16, and MCM-41.

In another embodiment the silicate material is SBA-15.

In another embodiment, the silicate material is prepared from a combination of ionic and non-ionic surfactants.

The invention also provides a method of catalyzing a chemical reaction comprising providing to the reaction a catalyst as described above. The chemical reaction may be a coupling reaction selected from Mizoroki-Heck, Suzuki-Miyaura, Stille, Kumada, Negishi, Sonogashira, Buchwald-Hartwig, and Hiyama reactions. In other embodiments, the chemical reaction may be selected from hydrosilylation, hydrogenation reactions and debenzylation reactions.

The invention also provides a method of preparing a catalyst comprising a functionalized silicate material and a metal, the method comprising:

synthesizing the functionalized silicate material by one-step co-condensation of a silicate precursor and a proportion of a functionalizing agent that is a ligand for the metal, wherein the silicate precursor is selected from:
(1) SiG₄₋ₐXₐ, where a is an integer from 2 to 4;
   G is an organic group selected from but not limited to:
   alkyl having from 1 to 20 carbon atoms, which may be straight chain, branched, or cyclic, substituted or unsubstituted;
   alkenyl having from 1 to 20 carbon atoms, which may be straight chain, branched, or cyclic, substituted or unsubstituted;
   aryl or heteroaryl, which may be substituted or unsubstituted; and
   alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
   X is a group capable of undergoing condensation, selected from but not limited to: alkoxy (OG (where G is defined as above)), halogen, allyl, phosphate, phosphate ester, alkoxycarbonyl, hydroxyl, sulfate, and sulfonato;
(2) metal silicates such as sodium ortho silicate; sodium meta silicate; sodium di silicate; or sodium tetra silicate;
(3) preformed silicates, such as kanemite;
(4a) organic/inorganic composite polymers such as silsesquioxanes of general structure E-R″-E, wherein:
   E is a polymerizable inorganic group such as a silica-based group, such as SiX₃, where X is defined as above; and
   R″ is selected from an aliphatic group such as —(CH₂)_{b}— where b is an integer from 1 to 20, which may be linear, branched, or cyclic, substituted or unsubstituted, and an unsaturated aliphatic group such as —(CH)_{b}— or —(C)_{b}—, including aromatic groups such as —(C₆H₄)_{b}— which may be substituted or unsubstituted;
(4b) organic/inorganic composite polymers such as polyalkylsiloxanes, polyarylsiloxanes, where the structure of the polymer is —[SiG₂O]_{z}— where G is as defined above and z is an integer from 10 to 200;
(5) a mixture of organic and inorganic polymers, for example a composite prepared by co-condensation between an inorganic silica precursor such as TEOS and a silsesequioxane precursor such as E-R″-E, or a co-condensation between TEOS and a siloxane terminated organic polymerizable group such as X₃Si—R″-Z, where Z is a polymerizable organic group such as an acrylate or styrene group, and X, E and R″ are defined as above, such as ORMOSIL type materials; and
(6) a pre-polymerized silicate based material with general formula SiO₂;

wherein the functionalizing agent is E-R″-Y, where E and R″ are as defined above and Y is a functional group comprising S, N, O, C, H, P, or a combination thereof;

filtering and drying the functionalized silicate material; and

combining the functionalized silicate material with a mixture of a dry solvent and one or more metals or complexes thereof selected from palladium, platinum, rhodium, iridium, ruthenium, osmium, nickel, cobalt, copper, iron, silver, and gold to obtain the catalyst.

The method may further comprise filtering the combination to obtain the catalyst.

The invention also provides a method of scavenging one or more metals from a solution, comprising:

providing a scavenger comprising a functionalized silicate material; and

combining the scavenger with the solution such that the one or more metals is captured by the scavenger;

wherein the scavenger is prepared by a method comprising:

synthesizing the functionalized silicate material by one-step co-condensation of a silicate precursor and a proportion of a functionalizing agent that is a ligand for the one or more metals;

wherein the silicate precursor is selected from:
(1) SiG₄₋ₐXₐ, where a is an integer from 2 to 4;
   G is an organic group selected from:
   alkyl having 1 to 20 carbon atoms, which may be straight chain branched, or cyclic, substituted or unsubstituted;
   alkenyl having 1 to 20 carbon atoms which may be straight chain, branched, or cyclic, substituted or unsubstituted;
   aryl or heteroaryl, which may be substituted or unsubstituted; and
   alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
   X is a group capable of undergoing condensation, selected from alkoxy (OG (where G is defined as above)), halogen, allyl, phosphate, phosphate ester, alkoxycarbonyl, hydroxyl, sulfate, and sulfonato;
(2) a metal silicate selected from sodium ortho silicate, sodium meta silicate, sodium di silicate, and sodium tetra silicate;
(3) a preformed silicate;
(4a) an organic/inorganic composite polymer including a silsesquioxane of general structure E-R″-E, wherein:
   E is a polymerizable inorganic silica-based group of the formula SiX₃, where X is defined as above; and
   R″ is selected from an aliphatic group of the formula —(CH₂)_{b}— where b is an integer from 1 to 20, which may be linear, branched, or cyclic, substituted or unsubstituted, and an unsaturated aliphatic group of the formula —(CH)_{b}— or —(C)_{b}—, including an aromatic group of the formula —(C₆H₄)_{b}—, which may be substituted or unsubstituted;
(4b) an organic/inorganic composite polymer selected from polyalkylsiloxane and polyarylsiloxane, where the structure of the polymer is —[SiG₂O]_{z}— where G is as defined above and z is an integer from 10 to 200;
(5) a mixture of organic and inorganic polymers, including a composite prepared by co-condensation of an inorganic silica precursor and a silsesequioxane precursor of the formula E-R″-E, or a co-condensation of an inorganic silica precursor and a siloxane terminated organic polymerizable group of the formula X₃Si—R″-Z, where Z is a polymerizable organic group selected from acrylate and styrene and X, E and R″ are defined as above; and
(6) a pre-polymerized silicate based material of general formula SiO₂; and

wherein the functionalizing agent is E-R″-Y, where E and R″ are as defined above and Y is a functional group comprising S, N, O, C, H, P, or a combination thereof; and

filtering and drying the functionalized silicate material.

### BRIEF DESCRIPTION OF THE DRAWING

Embodiments of the invention are described below, by way of example, with reference to the accompanying drawing, wherein:

FIG. 1 is a plot showing results of a split test for determination of presence of heterogeneous Pd in the reaction of 4-bromoacetophenone and phenylboronic acid catalyzed with SBA-15-SH.Pd.

### DETAILED DESCRIPTION OF PREFERRED EMBODIMENTS

### List of Abbreviations

TEOS, tetraethoxysilane [Si(OEt)₄]
MPTMS, mercaptopropyltrimethoxysilane [(MeO)₃SiCH₂CH₂CH₂SH]
APTES, aminopropyltriethoxysilane [(EtO)₃SiCH₂CH₂CH₂NH₂]
APTMS, aminopropyltrimethoxysilane [(MeO)₃SiCH₂CH₂CH₂NH₂]
P123, Pluronic-123, EO₂₀PO₇₀EO₂₀, where EO is ethylene oxide and PO is propylene oxide
F127, EO₉₇PO₆₇EO₉₇, where EO is ethylene oxide and PO is propylene oxide
SDS, sodium dodecyl sulfate
ORMOSIL, organically modified silicate

Feng et al. (1997), Mercier et al. (1997), and Pinnavaia et al. (2002 and 2003) demonstrated that mesoporous materials functionalized by grafting thiol thereto can be used as scavengers for mercury. Subsequently, in scavenging experiments Kang et al. (2003, 2004) demonstrated that mesoporous silica functionalized by grafting a thiol layer onto the silica surface has a higher affinity for Pd and Pt than other metals such as Ni, Cu, and Cd. We investigated the use of functionalized silicate materials as palladium scavengers and as palladium catalysts in the Mizoroki-Heck and Suzuki-Miyaura reactions. Functionalized silicate material was prepared two ways, and the scavenging and catalytic activity of the two forms were compared. Firstly, thiol-functionalized SBA-15 material (SBA-15-SH) was prepared in a manner similar to Kang et al. (2004) by grafting a 3-mercaptopropyltrimethoxysilane layer onto the surface of SBA-15 (see Example 1 for details). Materials prepared in this way are referred to herein as “grafted” materials, e.g., “grafted SBA-15-SH”. Secondly, SBA-15-SH material was prepared by incorporating the thiol into the sol gel silicate preparation (see Example 2 for details) in a manner similar to Melero et al. (2002). Materials prepared in this way are referred to herein as “sol gel” materials, e.g., “sol gel SBA-15-SH”. For comparisons of these materials as palladium catalysts, palladium was added to the materials as described in Example 3.

We examined the ability of grafted and sol gel SBA-15-SH materials to act as scavengers in removing palladium (PdCl₂ and Pd(OAc)₂) from aqueous and organic (THF) solutions, and compared their performance to other scavengers (see Example 11). We found that the grafted and sol gel SBA-15-SH materials were effective palladium scavengers, with similar effectiveness in removing palladium from the aqueous and organic solutions (Table 1). Montmorillonite clay and unfunctionalized SBA-15 were virtually ineffective as scavengers. Amorphous silica (SiO₂) functionalized with mercaptopropyl trimethoxysilane (SiO₂—SH) was the closest in effectiveness to SBA-15-SH, and thus was examined quantitatively (Table 1). The thiol-functionalized materials were also effective at removing Pd(0) from solution, depending on the ancillary ligands.

For example, Pd(OAc)₂ could be removed effectively with SBA-15-SH in either form (grafted: an initial 530 ppm solution was decreased to 0.12 ppm in THF; sol-gel: an initial 530 ppm solution was decreased to 95.5 ppb in THF). In addition, Pd₂ dba₃, where dba is dibenzylideneacetone, could be removed effectively with SBA-15-SH (a 530 ppm solution was decreased to 0.2 ppm using grafted SBA-15), but amorphous silica which was modified by grafting the thiol on the surface was not effective: a 530 ppm solution was reduced to 151.5 ppm). Neither grafted SBA-15-SH material nor amorphous silica which was modified by grafting the thiol on the surface was effective at removing Pd(PPh₃)₄ (initial 530 ppm solutions were reduced to 116 ppm and 214 ppm, respectively).

As shown in Table 1, at high concentrations of Pd (1500-2000 ppm), ca. 93% of the added Pd was removed using the grafted SBA-15-SH material (not determined for the sol gel SBA-15-SH material). At lower levels of initial contamination, better results were obtained: a solution containing about 1000 ppm of Pd was reduced to less than 1 ppm of Pd with grafted SBA-15-SH, and about 3 ppm with sol gel SBA-15-SH, which corresponds to removal of more than 99.9% of the palladium. Treatment of the same solution with amorphous silica-SH left 67 ppm of Pd in solution, although certainly part of this difference can be attributed to the lower loading of thiol on amorphous silica (1.3 mmol/g) compared to 2.2 mmol/g for grafted SBA-15-SH. Starting with a 500 ppm solution, treatment with grafted or sol gel SBA-15-SH resulted in removal of about 99.9998% (grafted) and 99.9975% (sol gel) of the Pd in solution, corresponding to a 500,000 fold reduction in Pd content after one treatment. Thus, although not examined in side-by-side trials, the sol gel SBA-15-SH scavenger appears to be competitive with commercially available polymer based scavengers such as SmopeX™ fibres (Johnson Matthey, London, GB), and superior to polystyrene based scavengers such as MP-TMT (available from Argonaut, Foster City, Calif.) where long reaction times (up to 32 h) and excess of scavenger are required.

TABLE 1
Scavenging of Pd with grafted and sol gel SBA-15-SH and SiO₂—SH^{a}

| | After grafted SBA-15-SH | | After amorphous SiO₂—SH | | After sol gel SBA-15-SH | |
|---|---|---|---|---|---|---|
| Initial [Pd] | treatment | | treatment | | treatment | |
| (ppm) | [Pd] (ppm) | % removed | [Pd] (ppm) | % removed | [Pd] (ppm) | % removed |
| 2120 | 152 | 92.85% | 193 | 90.93% | n.d. | n.d. |
| 1590 | 111 | 93.05% | 142 | 91.10% | n.d. | n.d. |
| 1060 | 0.908 | 99.91% | 67.42 | 93.66% | 3.5 | 99.6698% |
| 848 | 0.0052 | 99.9994% | 4.17 | 99.51% | 0.051 | 99.9936%^{b} |
| 530 | 0.0011 | 99.9998% | 1.16 | 99.78% | 0.013 | 99.9975% |
| 265 | 0.0005 | 99.99998% | n.d. | n.d. | 0.023 | 99.9913% |
| 106 | 0.00037 | 99.9996% | 0.0024 | 99.998% | n.d. | n.d. |

^{a}Aqueous solutions of PdCl₂ (10 mL) treated with 100 mg of silicate for 1 h with stirring. See Example 10 for full details.
^{b}Initial Pd concentration before treatment was 795 ppm rather than 848.
n.d.; not determined.

Surprisingly, however, the palladium-loaded grafted and sol gel SBA-15 materials were not the same when their catalytic activity was compared. Activity of the grafted SBA-15-SH.Pd was inconsistent from batch to batch, with many batches being completely ineffective. In contrast, the sol gel SBA-15-SH.Pd was consistently a very effective catalyst (see Table 2). The reason for the deficiency of the grafted material is under investigation, but may be related to at least one of: difficulty inherent during preparation in controlling the amount of thiol being grafted onto the silica surface; grafting occurring primarily in the micropores; the grafted thiol layer negatively affecting surface of the silicate material; uneven distribution of thiols throughout the material; and inability to promote reduction of the Pd(II) to Pd(0) catalyst. In addition, decreases in pore size observed upon grafting may be responsible for the inactivity observed with the grafted catalyst. Our results demonstrate that the catalytic activity of the sol gel SBA-15-SH.Pd material was consistently superior, producing high product yields, and was completely recyclable. Moreover, there was extremely low leaching of palladium from the sol gel material. These results suggest that the sol gel metallic catalysts such as SBA-15-SH.Pd are suitable for scale-up to production quantities in applications such as pharmaceutical, commodity chemical, agro-chemical, and electronic component manufacturing.

TABLE 2
Comparison of grafted and sol gel materials as catalysts for
the coupling of 4-bromoacetophenone and phenyl boronic acid

| Material | | Surface | Micropore | Pore | Sulfur | Conversion |
|---|---|---|---|---|---|---|
| (batch | Modification | Area | (area, volume) | diameter | content | (Yield) |
| number) | method | (m²/g) | (m²/g), (cm³/g) | (Å) | (mmol/g) | 80° C., 8 h |
| SBA-15 (1) | unmodified | 665 | 88.6, 0.031 | 56 | (n.a.) | (n.a.) |
| SBA-15-SH (1) | grafted | 410 | 0/0^{d} | 54 | 2.19 | 99% |
| SBA-15-SH (1) | vapour phase grafted | n.d. | n.d. | n.d. | n.d. | 65% (64%) |
| SBA-15 (2) | unmodified | 823 | 80.2, 0.02 | 50 | (n.a.) | (n.a.) |
| SBA-15-SH (2) | grafted | 409 | 0/0^{d} | 49 | n.d. | <5% |
| | | | | | | 65% (63%)^{a} |
| SBA-15 (3) | unmodified | 841 | 0.04, 112 | 48 | (n.a.) | (n.a.) |
| SBA-15-SH (3) | grafted | 593 | 0/0^{d} | 47 | 1.4 | <5% |
| | | | | | | 57% (55%)^{a} |
| SBA-15 (4) | unmodified | 712 | 68, 0.02 | 56 | (n.a.) | (n.a.) |
| SBA-15-SH (4) | grafted | 442 | 0^{d} | 54 | 1.59 | <5% |
| SBA-15 (5) | unmodified | 967 | 127, 0.043 | 55 | (n.a.) | (n.a.) |
| SBA-15-SH (5) | grafted | 362 | 0/0^{d} | 51 | 1.35 | <5% |
| SBA-15-SH | grafted | 328 | 2.9, 0 | 54 | 1.11 | <5% |
| low loading (5)^{b} | | | | | | |
| SBA-15-SH (5) | vapour phase grafted | n.d. | n.d. | n.d. | 0.79 | <5% |
| SBA-15-SH (6) | sol-gel | 633 | 5.1, 0.611 | 45 | 1.0 | 99% (98%) |
| SBA-15-SH (7) | sol-gel | 1110 | 180, 0.066 | 42 | 1.0 | 99% (98%) |
| | | | | 56^{c} | | |
| SBA-15-SH (8) | sol-gel | 798 | 130, 0.048^{e} | 36 | 1.3 | 99% (97%) |
| | | | 114, 0.040^{f} | 56^{c} | | |
| SBA-15-SH (9) | sol-gel | 735 | 0, 0.03 | 41 | 1.0 | 90% (85%) |
| SBA-15-SH (10) | sol-gel | 627 | 52, 0.589^{e} | 43 | 1.0 | 99% (97%) |
| | | | 52, 0.015^{f} | 48^{c} | | |
| SBA-15-SH (11) | sol-gel | 656 | 102, 0.037 | 36 | 1.0 | 99% (99%) |
| | | | | 45^{c} | | |
| SBA-15-SH (12) | sol-gel | 866 | 98, 0.031 | 45 | 1.0 | 99% (98%) |

^{a}Reaction performed at 100° C. for 24 h.
^{b}Loading was 2 mmol thiol per 1 g SBA-15.
^{c}Maximum value rather than average.
^{d}A value of 0/0 may also mean that the method used to calculate the microporosity is not effective with these materials.
^{e}Run 1
^{f}Run 2
n.d.; not determined. n.a.; not applicable.

This invention is based, at least in part, on the discovery that metallic catalysts using functionalized solid phase supports prepared by a sol gel method are superior to metallic catalysts using functionalized solid phase supports prepared by other techniques such as grafting. In particular, such catalysts have extremely low leaching of metals therefrom.

According to the invention, solid phase supports for metal catalysts are prepared using a sol gel process in which a silicate material and a functional group, are combined during sol gel synthesis of the functionalized silicate material. The functional group is attached to the solid phase, optionally by a linker. The functional group attracts and binds a selected metal, and is selected on the basis of the metal of interest. Where two or more metals are involved, two or more corresponding functional groups may be selected. The term “metal” is meant to imply the element in question in any state, i.e., as a molecular covalent or ionic complex, or as the metal itself, such as, for example, in the form of nanoparticles or a colloidal dispersion. Materials prepared in this way are referred to herein as “sol gel” materials. The catalysts may be referred to herein as “heterogeneous” catalysts, in that they are predominantly present as a solid phase. The metal, or a combination of more than one metal, may be combined with the sol gel solid phase support either during or after sol gel synthesis of the solid phase. The sol gel solid phase supports alone (i.e., not combined with one or more metals) may also be used as scavengers for one or more metals.

A solid phase support suitable for making a catalyst according to the invention may be prepared by a sol gel method comprising synthesizing a silicate material by one-step co-condensation of a silicate material and a functionalizing agent that will act as a ligand for the metal, followed by filtering and drying the functionalized silicate material.

As used herein, the terms “silica” and “silicate” are considered to be equivalent and are interchangeable. The silicate material may comprise a silicate precursor and a proportion of a functionalizing agent that is a ligand for the metal, where the silicate material is formed using any of the following precursors:
(1) SiG₄₋ₐXₐ, where a is an integer from 2 to 4;
   G is an organic group selected from but not limited to:
   alkyl having from 1 to 20 carbon atoms, which may be straight chain, branched, or cyclic, substituted or unsubstituted;
   alkenyl having from 1 to 20 carbon atoms, which may be straight chain, branched, or cyclic, substituted or unsubstituted;
   aryl or heteroaryl, which may be substituted or unsubstituted; and
   alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
   X is a group capable of undergoing condensation, selected from but not limited to: alkoxy (OG (where G is defined as above)), halogen, allyl, phosphate, phosphate ester, alkoxycarbonyl, hydroxyl, sulfate, and sulfonato;
(2) metal silicates such as sodium ortho silicate; sodium meta silicate; sodium di silicate; or sodium tetra silicate;
(3) preformed silicates, such as kanemite;
(4a) organic/inorganic composite polymers such as silsesquioxanes of general structure E-R″-E, wherein:
   E is a polymerizable inorganic group such as a silica-based group, such as SiX₃, where X is defined as above; and
   R″ is selected from an aliphatic group such as —(CH₂)_{b}— where b is an integer from 1 to 20, which may be linear, branched, or cyclic, substituted or unsubstituted, and an unsaturated aliphatic group such as —(CH)_{b}— or —(C)_{b}—, including aromatic groups such as —(C₆H₄)_{b}— which may be substituted or unsubstituted;
(4b) organic/inorganic composite polymers such as polyalkylsiloxanes, polyarylsiloxanes, where the structure of the polymer is —[SiG₂O]_{z}— where G is as defined above and z is an integer from 10 to 200;
(5) a mixture of organic and inorganic polymers, for example a composite prepared by co-condensation between an inorganic silica precursor such as TEOS and a silsesequioxane precursor such as E-R″-E, or a co-condensation between TEOS and a siloxane terminated organic polymerizable group such as X₃Si—R″-Z, where Z is a polymerizable organic group such as an acrylate or styrene group, and X, E and R″ are defined as above, such as ORMOSIL type materials; and
(6) a pre-polymerized silicate based material with general formula SiO₂.

In one embodiment, the silsesequioxane precursor is X₃Si—R″—SiX₃, where X and R″ are as defined above. In another embodiment, G is Me or Ph or a combination thereof. In another embodiment, G is —(CH₂)₂— or —C₆H₄— or —C₆H₄—C₆H₄— or a combination thereof, and E is Si(OEt)₃ or Si(OMe)₃. In another embodiment the silicate material is a mesoporous silicate material, such as, for example, SBA-15, FSM-16, and MCM-41. A preferred material is SBA-15.

The functionalizing agent may be introduced in the form of X₃₋ₑGeSi—R″-Y, where e is an integer from 0 and 2, R″, G, and X, are defined as above, and Y is a functional group based on any of the following elements: S, N, O, C, H, P, including, but not limited to: SH, NH₂, PO(OH)₂, NHCSNH₂, NHCONH₂, SG, NHG, PG₃, PO(OG)₂, NG₂, imidazole, benzimidazole, thiazole, POCH₂COG, crown ethers, aza or polyazamacrocycles and thia macrocycles. Y may also be an aromatic group such as benzene, naphthalene, anthracene, pyrene, or an aliphatic group where Y is (—CH₂)_{b}—H where b is an integer from 1 to 20.

In some embodiments the functional group may be provided in a precursor form, such that an additional reaction is needed to render it an effective ligand. In a preferred embodiment, the ligand is a thiol, which may be added either as the thiol itself (Example 2), or as a disulfide which is pre-reduced to the thiol prior to addition of the metal (Example 10). The ligand may be ionic, such as a member of the class of compounds defined above as X, or non-ionic, wherein the non-ionic ligand is selected from P, S, O, N, C and H. For example, such ligands may include PG₃, SG₂, OG₂ or NG₃, where G is defined as above and may also be H. In another embodiment the trialkoxysilane-modified ligand (i.e., the functionalizing agent) is of the form [Y—(CH₂)_{b}—SiX₃], where Y is a functional group as described above, and b is an integer from 1 to 20. In other embodiments the functionalizing agent may be thiol, disulfide amine, diamine, triamine, imidazole, phosphine, pyridine, thiourea, quinoline, or a combination thereof.

The method of making a silicate material for use as a catalyst of the invention may comprise, in some embodiments, adding a porogen or structure-directing agent (SDA) during the condensation to introduce porosity to the silicate material. In such embodiments the SDA may be removed, e.g., by extraction, before combining the functionalized silicate material with the metal. The SDA may be a non-ionic surfactant porogen or surfactant such as, for example, an aliphatic amine, dodecyl amine, or α-, β-, or γ-cyclodextrin. The SDA may also be a non-ionic polymeric surfactant such as Pluronic™ 123 (P123, which has the chemical formula (EO)₂₀(PO)₇₀(EO)₂₀ (where EO is ethyleneoxide and PO is propyleneoxide)) (Aldrich). In addition, the SDA may be a combination of surfactants, such as, for example, a combination of an ionic and a non-ionic surfactant, or a combination of a cationic and a non-ionic surfactant.

For example, the SDA may be a combination of sodium dodecyl sulfate (SDS) and P123, or a combination of a cationic surfactant such as CTAB (cetyltrimethylammonium bromide) and a non-ionic surfactant such as Brij5™ (C₁₆EO₁₀). Preferably the SDA is a combination of an anionic surfactant and a non-ionic surfactant. In a preferred embodiment, the SDA is a combination of SDS and a polyether surfactant such as P123, F127, or a Brij-type surfactant. More preferably, the SDA is a combination of SDS and P123. In further embodiments, the SDA may include a combination of one or more surfactants and a pore expander such as trimethyl benzene.

In some embodiments, during preparation of a catalyst the metal or metals may be incorporated into the sol gel process as a pre-ligated complex of a form such as LmM[Y—(CH₂)_{b}—SiX₃]ᵣ₋ₘ, where X is as defined above, Y is a functional group as defined above, M is the metal, r is the coordination number of the metal, L is a ligand for the metal, m is an integer from 0 to r, and b is an integer from 1 to 20, preferably from 2 to 4. Alternatively, the metal or metals may be incorporated as precomplexed metal nanoparticles (see Example 9). In other embodiments, the metal may be provided as a salt, an ionic complex, a covalent complex, or as preformed nanoparticles. In the case of the latter, the metal nanoparticles are preferably protected with a trialkoxysilane-modified ligand of the form [Y—(CH₂)_{b}—SiX₃], where Y is the functional group, X is as set forth above, and b is an integer from 1 to 20, or by exchangeable ligands selected from, but not limited to phosphines, thiols, tetra-alkylammonium salts, halides, surfactants, and combinations thereof. Alternatively, the metal nanoparticles' may be protected by ligands which are then replaced by the ligands present on the surface of previously synthesized functionalized silicate. In this case, the ligands may be selected from, but are not limited to phosphines, thiols, tetra-alkylammonium salts, halides, surfactants, and combinations thereof. Such combinations are routinely used as ligands on metal nanoparticles, their purpose being to prevent unwanted agglomeration of the metal nanoparticles (Kim et al. 2003). Metal nanoparticles may also be adsorbed after preparation in solutions containing stabilizers, such as, for example, surfactants, phase transfer catalysts, halide ions, carboxylic acids, alcohols, and polymers. In another embodiment, the nanoparticles may be prepared in an SDS solution either prior to use of the SDS as the SDA for the silicate synthesis, or the nanoparticles may be introduced after the synthesis of the silicate material is complete. Metals may also of course be incorporated with the functionalized silicate material after preparation of the functionalized silicate material, using methods such as those described in Examples 3, 5, and 7.

Metallic catalysts prepared according to the invention are effective, stable catalysts with minimal metal leaching which may be as low as in the part-per-billion range (corresponding to 0.001% of the initially added catalyst), and produce high yields. Hence the catalysts are useful wherever high-purity reaction products are desired, such as, for example, in the pharmaceutical industry (Garrett et al. 2004), and the manufacture of electronic devices from conjugated organic materials (Nielsen et al. 2005). For example, preferred embodiments may be used to catalyze the Mizoroki-Heck, Suzuki-Miyaura, Stille, Kumada, Negishi, Sonogashira, Buchwald-Hartwig, or Hiyama coupling reactions, or hydrosilylation reactions, or indeed any metal-catalyzed coupling reaction, as well as hydrogenation and debenzylation reactions.

Functionalized solid phase supports prepared using a sol gel process as described herein are also very effective as metal scavengers in removing metals such as palladium and ruthenium from aqueous and organic solutions. Scavengers and catalysts prepared according to the invention are also useful in preparing films and polymers in industries such as electronic device manufacturing where device performance may be related to purity of films and polymers used in their fabrication (Neilsen et al. 2005).

Solid phase supports are preferably silicate materials with high porosity. Solid phase supports may be any material in which porosity is introduced either through a surfactant template or porogen, or in which porosity is inherent to the structure of the material, including organic/inorganic composites such as silsequioxanes including PMOs (periodic mesoporous organosilicas; Kuroki et al. 2002). The inventors envision an organic/inorganic composite material wherein there is no covalent linkage between the organic and inorganic moieties. A preferred silicate material is made using either Pluronic 123 or Pluronic 123 and SDS.

The functionalizing group may be, for example, amine, diamine, triamine, thiol (mercapto), thiourea, disulfide, imidazole, phosphine, pyridine, quinoline, etc., and combinations thereof, depending on the metal or metals of interest. The functionalizing group may optionally be attached to the solid phase via a linker, such as, but not limited to, alkyl, alkoxy, aryl. In addition, the functionalizing group may be, attached by the reaction of allyl groups with surface silanols (Kapoor et al. 2005; Aoki et al. 2002). Preferred functionalizing groups are thiols and amines, where the combination of functionalizing group and linker is, for example, mercaptopropyl and aminopropyl, respectively. Accordingly, 3-mercaptopropyltrimethoxysilane (MPTMS) and 3-aminopropyltrimethoxysilane (APTMS) may be used to prepare functionalized silicates of the invention. Metals may be, for example, any of palladium, platinum, rhodium, iridium, ruthenium, osmium, nickel, cobalt, copper, iron, silver, and gold, and combinations thereof. Preferred metals are palladium, platinum, rhodium, iridium, ruthenium, osmium, nickel, cobalt, copper, iron, silver, and gold, with palladium being more preferred.

In a preferred embodiment, the functionalized sol gel material is prepared from tetraethoxysilane (TEOS) in the presence of either P123 or P123 and SDS, where the ligand is MPTMS. Synthesis of the material may be carried out in a number of ways. In a preferred method, thiol MPTMS is pre-mixed with an appropriate amount of TEOS, and both are added to a pre-heated mixture of surfactant such as Pluronic 123 (P123), acid, and water. Various amounts of thiol may be added, for example, 6%, 8%, 10%, and up to about 20% (wt/wt TEOS) thiol, with larger quantities of thiol leading to less ordered materials. In another embodiment, functionalized SBA-15 is synthesized from the disulfide (SBA-15-S-S-SBA-15), wherein the disulfide bond is cleaved to provide two thiols (Dufaud et al. 2003) (see Example 10).

The ability of palladium-loaded sol gel SBA-15-SH.Pd (for preparation, see Example 3) to act as a catalyst was examined in detail. It will be appreciated that, in the case of SBA-15-SH.Pd, for example, the functionalizing group may be attached to the silicate via a linker. Surprisingly, even materials that had a large excess of thiol on the support relative to Pd (e.g., 10:1) exhibited high catalytic activity for Suzuki-Miyaura (Example 12) and Mizoroki-Heck (Example 13) reactions of bromo and chloroaromatics, and did not leach Pd into solution. At the end of the reaction, using loadings as high as 2%, as little as 3 ppb Pd was observed in solution, accounting for only 0.001% of the initially added catalyst. In particular, the results from sol gel SBA-15-SH material having a 4:1 S:Pd ratio are shown in Table 3. No difference in activity was found for catalysts that had anywhere from 2:1 to 10:1 thiol to Pd ratios.

TABLE 3
Suzuki-Miyaura couplings with sol gel SBA-15-SH•Pd^{a}

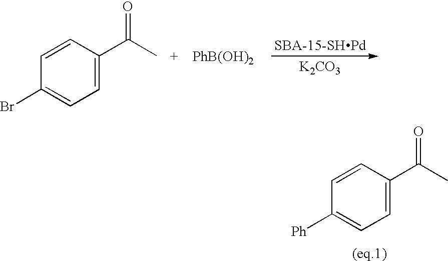

| | Catalyst | | Conv. | Pd leaching | Leaching of |
|---|---|---|---|---|---|
| Entry | support | Solvent | (yield) | (%, ppm)^{c} | Si, S (ppm) |
| 1 | SBA-15 | H₂O^{d} | 99 (98) | 0.001, 0.003 | n.d.^{e} |
| 2 | SBA-15 | H₂O^{f} | 97 | 0.04, 0.09 | n.d.^{e} |
| 3^{g} | SBA-15 | DMF/H₂O^{b} | 99 | 0.009, 0.02 | n.d.^{e} |
| 4 | SBA-15 | H₂O | 99 (97) | 0.04, 0.09 | 168, 36 |
| 5^{h} | SBA-15 | H₂O | 93 (80) | 0.019, 0.08 | 108, 6 |
| 6 | SBA-15 | DMF | 96 (94) | 0.35, 0.75 | 14, 1.7 |
| 7 | SiO₂ | DMF | 33 (31) | 0.61, 1.30 | 20, 6.4 |
| 8 | SiO₂ | H₂O | 99 (98) | 0.39, 0.84 | 155, 17 |
| 9 | SBA-15ⁱ | DMF | 33 (31) | n.d.^{e} | n.d.^{e} |

^{a}Unless otherwise noted, reaction conditions are: 1% catalyst, 8 h, 80° C. Conversions and yields are determined by gas chromatography (GC) vs internal standard unless otherwise noted.
^{b}DMF/H₂ O in a 20/1 ratio.
^{c}As a % of the initially added Pd, and the ppm of the filtrate, determined by ICPMS.
^{d}80° C., 5 h.
^{e}Not determined.
^{f}100° C., 2 h.
^{g}Bromobenzene was employed.
^{h}Chloroacetophenone was used with 2% catalyst, 24 h, 80° C.
ⁱThe catalyst was prepared by sol-gel incorporation of the disulfide of MPTMS followed by cleavage of the S—S bond with triphenyl phosphine and water.

With the sol-gel SBA-15-SH.Pd material, high catalytic activity was observed in either dimethylformamide (DMF), water, or a mixture of the two solvents. Most notably, extremely low leaching of the catalyst was observed. In all cases, less than 1 ppm of Pd was present in the solution at the end of the reaction, in some cases as little as 3 ppb Pd was observed, corresponding to a loss of only 0.001% of the initially added catalyst. Samples taken at low conversions (22%, 42%) showed no increase in leaching, indicating that the catalyst was not leaching and re-adsorbing after the reaction (Lipshutz et al. 2003, Zhao et al. 2000). As used herein, the term “conversion” is intended to mean the extent to which the catalyzed reaction has progressed.

The filtrate was also examined for the presence of silicon and sulfur. As shown in entries 4 and 5 of Table 3, both were observed for reactions run in water. However, in DMF, silicon and sulfur leaching was dramatically suppressed but slightly higher Pd leaching was observed (0.35% of 1%, or 0.75 ppm) (entry 6). Using commercially available silica gel-supported thiol (entries 7 and 8), decreased reactivity was observed in DMF at 80° C. (entry 6), but reactivity could be restored at higher temperature (90° C., 97% conversion, 92% yield). The catalyst prepared using the disulfide of MPTMS followed by reduction to thiol with triphenyl phosphine gave some activity, although lower than was observed by incorporation of the thiol itself (entry 9).

Although only a few heterogeneous catalysts have been reported to promote the Suzuki-Miyaura reaction with chloroarenes (Choudary et al. 2002, Baleizão et al. 2004, Wang et al. 2004), with homogeneous catalysts being more active for chloroarene couplings (Littke et al. 2002), reaction was observed with our catalyst at temperatures as low as 80 to 100° C. (Table 3, entry 5 and Table 4, entries 1 and 2). Heteroaromatic substrates such as, for example, 3-bromopyridine, deactivated substrates such as, for example, 4-bromoanisole, and even chloroacetophenone and chlorobenzene underwent coupling reactions with good to excellent yields (Table 4), although the latter two required higher loadings. The catalysts could be reused multiple times with virtually no loss of activity, even in water (Table 5). For the SiO₂—SH.Pd catalyst, a small loss of activity was observed in the first reuse, and after that, the catalyst was completely recyclable. In reactions such as hydrogenations, the oxidation state of the metal catalyst may change during the reaction. For example, Pd(II) may become Pd(0) even in the lower oxidation state, the catalyst is still active and is thus reusable.

TABLE 4
Substrate scope for the Suzuki-Miyaura coupling^{a}

| | | | Conv. (yield) |
|---|---|---|---|
| Entry | Substrate | Solvent | (%) |
| 1 | 4-chlorobenzene | DMF | (67)^{b} |
| 2 | 4-chloroacetophenone | H₂O | 99 (96)^{b} |
| 3 | 3-bromopyridine | DMF/H₂O | 99 (98) |
| 4 | 4-bromotoluene | DMF/H₂O | (82)^{b} |
| 5 | 4-bromoanisole | H₂O | 99 (96)^{b} |
| 6 | 4-bromobenzaldehyde | H₂O | 99 (97)^{b} |

^{a}Reactions performed at 90° C. for 15 h with 1% catalyst, and at 100° C. for 24 h with 2% catalyst for chloroarenes.
^{b}Isolated yields.

TABLE 5
Reusability of the catalyst in the Suzuki-Miyaura reaction
of 4-bromoacetophenone with phenylboronic acid.

| | | | | Conv. |
|---|---|---|---|---|
| Entry | Catalyst | Solvent | Conditions | (yield) (%) |
| 1 | SBA-15-SH•Pd | DMF/H₂O | 8 h/80° C. | 99 (98) |
| 2 | 1^{st} recycle | DMF/H₂O | 8 h/80° C. | 99 (97) |
| 3 | 2^{nd} recycle | DMF/H₂O | 8 h/80° C. | 98 (97) |
| 4 | 3^{rd} recycle | DMF/H₂O | 8 h/80° C. | 96 (95) |
| 5 | 4^{th} recycle | DMF/H₂O | 8 h/80° C. | 96 (95) |
| 6 | SBA-15-SH•Pd | H₂O | 5 h/80° C. | 99 (98) |
| 7 | 1^{st} recycle | H₂O | 5 h/80° C. | 99 (99) |
| 8 | 2^{nd} recycle | H₂O | 5 h/80° C. | 99 (97) |
| 9 | 3^{rd} recycle | H₂O | 5 h/80° C. | 98 (96) |
| 10 | 4^{th} recycle | H₂O | 5 h/80° C. | 96 (92) |
| 11 | SiO₂—SH•Pd | H₂O | 5 h/80° C. | 96 (95) |
| 12 | 1^{st} recycle | H₂O | 5 h/80° C. | 84 (82) |
| 13 | 2^{nd} recycle | H₂O | 5 h/80° C. | 81 (78) |
| 14 | 3^{rd} recycle | H₂O | 5 h/80° C. | 80 (77) |

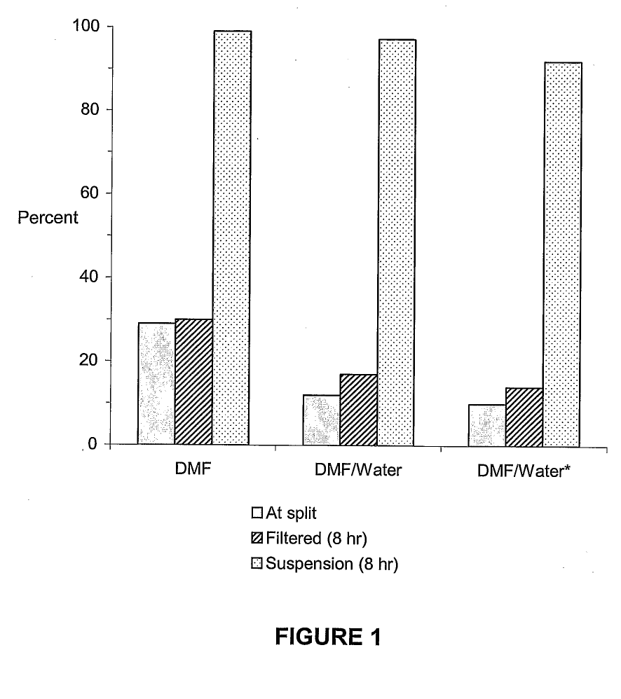

To confirm that the Suzuki-Miyaura reaction was proceeding through use of a truly heterogeneous catalyst, we performed several tests (see Example 14). Firstly, we attempted the reaction with 500 ppb of Pd(OAc)₂ since traces of Pd have been reported to have high catalytic activity (Arvela et al. 2005), and found less than 5% conversion after 8 h at 80° C. Secondly, we carried out a hot-filtration test (Sheldon et al. 1998), which entailed filtering half the solution either 1 or 3 h after the reaction had begun. Both portions were heated for a total of 8 h. When this was carried out in DMF solvent, the portion containing the suspended catalyst proceeded to 97% conversion, while the catalyst-free portion reacted only an additional 1%. In 4/1 DMF/water, the catalyst-free portion reacted an additional 5%. One final split test was performed in which the second flask which received the filtered catalyst had phenyl boronic acid and potassium carbonate in it. Again, only 5% additional reaction was observed (see FIG. 1).

Finally, we performed a three phase test (Davies et al. 2001, Baleizão et al. 2004), in which one substrate was immobilized to silica, and conversion of this substrate was attributed to the action of homogenous catalyst. Under typical Suzuki-Miyaura reaction conditions, ca. 5% of immobilized aryl bromide was converted to product, and none of immobilized aryl chloride was converted to product. These experiments showed that although traces of Pd leach from support and are catalytically active, the vast majority (i.e., >95%) of the catalysis is carried out by truly heterogenous Pd catalyst, possibly in the form of immobilized Pd nanoparticles, i.e., leaching is minimal.

The Mizoroki-Heck reaction of styrene with 4-bromoacetophenone, bromo and iodobenzene (eq. 2) was also catalyzed by sol gel SBA-15-SH.Pd and SBA-15-NH₂.Pd (Table 6). Again, the catalyst showed good activity and Pd leaching was minimal (less than 0.25 ppm, entries 2 and 3). Interestingly, although the amine-functionalized silicate was also an active catalyst, Pd leaching was substantial, 35 ppm, entry 5. This corresponds to almost 10% of the initially added catalyst, illustrating the preference of the thiol-modified surface for retaining Pd.

TABLE 6
Sol gel SBA-15-NH₂•Pd and SBA-15-SH•Pd catalysts for the
Mizoroki-Heck reaction^{a}

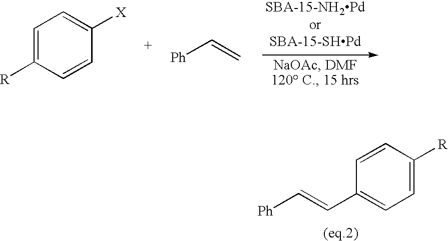

| | Substrate | | Conv. | Pd leaching |
|---|---|---|---|---|
| Entry | (R/A) | Catalyst (loading) | (yield) | (ppm) |
| 1 | H/Br | SBA-15-SH•Pd (1%) | 98% | <2^{b} |
| 2 | COMe/Br | SBA-15-SH•Pd (0.5%) | 99% | 0.23 |
| 3 | COMe/Br | Reuse (entry 3, 0.5%) | 98% | 0.27 |
| 4 | H/I | SBA-15-NH₂•Pd (1%) | 99% (96) | n.d. |
| 5 | H/Br | SBA-15-NH₂•Pd (1.5%) | 99% | 35 |

^{a}Unless otherwise noted, reaction conditions are: 120° C., 1 mmol of halide, 1.5 mmol olefin, 2 mmol NaOAc, DMF, 15 h.
^{b}Determined by atomic absorption.
n.d.; not determined.

In addition, catalytic activity was found in thiol-modified material prepared by a liquid crystal templating method which is a modification of that described by El-Safty et al. (El-Safty 2005) (Example 8). A block co-polymer template which has very short polar chains (L121, EO₅PO₇₀EO₅) was used as the surfactant with TMOS (Si(OMe)₄ as the silica source. According to the literature, the resulting materials are cubic or wormhole. The material was treated hydrothermally after synthesis in order to increase the pore diameter and stability. The block co-polymer P123 may also be used with this method. The advantage of this method is that it can be used to make materials in monolith form, and within a shorter time. After absorption of Pd as described in the below examples, the resulting materials displayed catalytic activity for the Suzuki-Miyaura reaction of 4-bromoacetophenone and the pinacol ester of phenylboronic acid. The results of this reaction and the physical properties of the liquid-crystal templated catalyst are shown in Table 7.

Active catalysts were also generated by combination of ionic and non-ionic surfactants. The addition of an ionic surfactant along with a neutral block co-polymer surfactant has the advantage that one can obtain different structures (e.g., hexagonal, cubic) and morphologies using the same (pluronic) surfactant and a small amount of another surfactant, in this case SDS.

Materials were prepared based on the method of Chen et al. (Chen 2005) with the same amount of P123. In this case, SDS induces P123 to yield a cubic structure, which is obtained normally with other surfactants like F127. It was found that co-condensing TEOS and MPTMS at the same time did not give good materials, presumably due to the faster. condensation of MPTMS. Thus the procedure was modified so that TEOS was first added and then mercaptotrimethoxysilane (Margolese 2000).

Interestingly, when a material was prepared by the same method, but stirred during aging, no catalytic activity was observed. In addition, material prepared with lower amounts of P123 also gave no catalytic activity. The properties and catalytic activity of the material prepared as described in Example 6 and 8 are given in Table 7.

TABLE 7
Nitrogen adsorption data and catalytic activity for
materials prepared under alternative conditions.

| | Specific | BJH | | Catalytic |
|---|---|---|---|---|
| | Surface Area | adsorption | Total pore | Activity |
| Material | BET (m²/g) | (Å) | volume (mL/g) | yield (GC) |
| L121 | 664 | 68.7 | 1.120 | (87.5) |
| templated | | | | |
| P123/SDS | 643 | 52.9 | 0.950 | (57.2) |
| templated | | | | |

All cited references are incorporated herein by reference in their entirety.

The invention is further described by way of the following non-limiting examples.

### Example 1

### Preparation of Grafted SBA-15-SH

(CH₃O)₃Si(CH₂)₃SH (1 mL, 5.3 mmol) and pyridine (1 mL, 12.3 mmol) were added dropwise to a suspension of SBA-15 (Zhao et al. 1998a, b) or SiO₂ (1 g) in dry toluene (30 mL), under N₂ atmosphere. The resulting mixture was refluxed at 115° C. for 24 hours. After cooling, the suspension was filtered and the solid residue was washed with methanol, ether, acetone and hexane to eliminate unreacted thiol. The resulting solid was dried under vacuum at room temperature giving a white powder. Brauner Emmet Teller (BET) surface area is 410 m²/g for SBA-15-SH; elemental analysis of sulfur is 2.2 mmol/g and BET surface area is 297 m²/g for SiO₂—SH and elemental analysis of sulfur is 1.3 mmol/g).

### Example 2

### Preparation of Sol Gel SBA-15-SH

The synthesis of 3-mercaptopropyltrimethoxysilane (MPTMS)-functionalized SBA-15 materials was similar to that of pure-silica SBA-15 (Zhao et al. 1998a, b), except for adding varying amounts of MPTMS, as described in Melero et al. (2002). Samples were synthesized by one-step co-condensation of tetraethoxysilane (TEOS) and various proportions of MPTMS which were mixed in advance in the presence of tri-block copolymer Pluronic 123 (P123, which has the chemical formula (EO)₂₀(PO)₇₀(EO)₂₀ (where EO is ethyleneoxide and PO is propyleneoxide)) (Aldrich). Varying ratios of TEOS:MPTMS were employed along with 4 g of P123, 120 mL of 2 M HCl, and 30 mL of distilled water. The molar ration of TEOS:MPTMS follows the formula y moles TEOS and (0.041-y) moles of MPTMS, where y is 0.041, 0.0385, 0.0376, 0.0368, 0.0347, corresponding to MPTMS concentrations of 0, 6, 8, 10, 15 mole %, respectively. After aging for 48 h at 80° C., the solid samples were filtered, washed with ethanol, and dried at room temperature under vacuum. Removal of surfactant P123 was conducted by using ethanol extraction at 70° C. for 3 days.

### Example 3

### Preparation of SBA-15-SH.Pd

50 mL of 0.05M Pd(OAc)₂ in dry THF solution was prepared in a Schlenk flask under an inert atmosphere. To this was added 1 g of SBA-15-SH or SiO₂—SH and the mixture stirred at room temperature for 1 hour. The solid catalyst was then filtered and washed with THF and vacuum dried at room temperature.

### Example 4

### Preparation of Sol Gel SBA-15-NH₂

The synthesis of 3-aminopropyltrimethoxysilane (APTMS) functionalized SBA-15 materials was similar to that of pure-silica SBA-15, except for adding varying amounts of APTMS (see Wang et al. (2005). Samples were synthesized by one-step co-condensation of triethoxysilane (TEOS) and different proportions of APTMS which were mixed in advance in the presence of tri-block copolymer Pluronic 123 (P123). Varying ratios of TEOS:APTMS were employed along with 4 g of P123, 120 mL of 2 M HCl, and 30 mL of distilled water.

The molar ration of TEOS:APTMS follows the formula b moles of TEOS and (0.041-b) moles of APTMS, where b is 0.041, 0.0385, 0.0376, 0.0368, 0.0347, corresponding to APTMS concentrations of 0, 6, 8, 10, 15 mole %, respectively. After aging for 48 h at 80° C., the solid samples were filtered, washed with ethanol, and dried at room temperature under vacuum. Removal of surfactant P123 was conducted by using ethanol extraction at 70° C. for 3 days.

### Example 5

### Preparation of SBA-15-NH₂.Pd

50 ml of 0.05M Pd(OAc)₂ in dry THF solution was prepared in a Schlenk flask under an inert atmosphere. To this 1 g of SBA-15-NH₂ was added and the mixture stirred at room temperature for 1 hour. The solid catalyst was filtered and washed with THF and vacuum dried at room temperature.

### Example 6

### Preparation of Thiol-Modified Material Employing a Mixture of Surfactants P123 and SDS

P123 (2.0385 g) and SDS (0.2298 g) were dissolved in 52 mL of water and 24 g 2 M HCl solution (5 mL 37% HCl and 25 mL water) by stirring in a closed glass bottle at 30° C. for 3-4 h.

TEOS (3.9968 g) was then added to the clear solution. The mixture was stirred for 3 h at 30° C. Then mercaptopropyltrimethoxysilane (MPTMS, 0.25 mL) was added to the resulting white solution. The mixture was stirred for 24 h (after the TEOS addition) at 30° C., and then aged at 100° C. for and additional 24 h. The solid was recovered by filtration and washed with 200 mL of water and 200 mL of ethanol.

The surfactants were extracted by pouring the solid into a mixture of 150 mL ethanol and 1.5 mL 37% HCl and stirring at 60° C. for 4 h. The solid was recovered by filtration, washed with ethanol and diethyl ether, then dried at 150° C. for 1 h. 1.6968 g of a colourless powder was recovered.

### Example 7

### Preparation of Pd Catalyst Derived from a Thiol-Modified Material Prepared by Employing a Mixture of Surfactants P123 and SDS

17.0 mg (0.076 mmol) of palladium acetate was dissolved in 12 mL of column dry THF. The resulting solution was stirred under an argon atmosphere for 15 minutes to ensure complete dissolution. 248.8 mg of P123/SDS templated thiol modified silicate was then added to the solution and stirred under argon for 1 h at room temperature. After 1 h the catalyst was filtered using a sintered glass funnel, scraped into a vial and dried overnight under high vacuum.

### Example 8

### Preparation of a Thiol-Modified Material Using L121 as a Liquid Crystal Template

L121 (EO₅PO₇₀EO₅, 2.2860 g) was mixed with mercaptopropyl-trimethoxysilane (MPTMS, 0.1955 g) and TMOS (Si(OMe)₄, 2.3356 g) for 5 minutes at 40° C. in a round; bottomed flask connected to a rotary evaporator. 1.4 mL HCl solution at pH=1.3 was then added. After stirring for 10 min at 40° C. (when the sol-gel is clear), the system was put under vacuum for 10 min first at 430 mmHg and then 10 min at 150 mmHg. The resulting solid was allowed to cure in an open flask for 24 h at 40° C. The solid was then hydrothermally treated by adding 55 mL water and allowing it to cure at 95° C. for 24 h. The solid was recovered by filtration, washed with water and allowed to dry at room temperature.

The surfactants were extracted by pouring the resulting solid into a mixture of 300 mL ethanol and 3 mL 37% HCl and stirring at 60° C. for 4 h. The solid was recovered by filtration and washed with ethanol and then diethyl ether. The solid was dried for 1 h at 150° C. 1.6994 g of a colourless powder was recovered.

### Example 9a

### Synthesis of Pd-Modified Thiol-Containing (Pd-SBA-15-SH/NH₂) Mesoporous Materials Using Stabilized Pd Nanoparticles as the Pd Source

To a 0.05 M solution of palladium acetate in dry THF (50 mL) was added 0.05 g of sodium borohydride (NaBH₄) at room temperature to yield a blackish-brown coloured solution, indicating the formation of palladium nanoparticles. These palladium nanoparticles were treated with various ratios of organic-soluble mercaptopropyltriethoxysilane or aminopropyltriethoxysilane. The mixture was then stirred rapidly at room temperature until formation of alkanethiol/amine stabilized palladium particles was complete. Evaporation of the solvent yielded stabilized Pd nanoparticles. In a second flask, P123 [(EO)₂₀(PO)₇₀(EO)₂₀] (4 g) was dissolved in H₂O (120 mL) and 2M HCl (30 mL) and heated to 35° C. for 19 h. 10 mL of this solution was added to the palladium nanoparticles stabilized by MPTMS or APTMS prepared previously. TEOS (0.0385 moles) was then added to this mixture and the resulting combined TEOS/Pd nanoparticle mixture added into the remaining P123/H₂O/HCl mixture. After aging for 48 h at 80° C., the solid samples were filtered, washed with ethanol, and dried at room temperature under vacuum. Removal of surfactant P123 was conducted by using ethanol extraction at 70° C. for 3 days.

### Example 9b

### Preparation of Pd Catalyst Derived from a Thiol-Modified Material Made with L121 as a Liquid Crystal Template

16.6 mg (0.074 mmol) of palladium acetate was dissolved in 12 mL of dry THF. The resulting solution was stirred under an argon atmosphere for 15 minutes to ensure complete dissolution. 253.4 mg of liquid-crystal templated thiol modified silicate was then added to the solution and stirred under argon for 1 h at room temperature. After 1 h the catalyst was filtered using a sintered glass funnel, scraped into a vial and dried overnight under high vacuum.

### Example 10

### Synthesis of bis(trimethoxysilyl)propyldisulfide Functionalized SBA-15

The synthesis of bis(trimethoxysilyl)propyldisulfide (BTMSPD) functionalized SBA-15 is similar to that of SBA-15, with the exception that BTMSPD was premixed in various amounts with tetraethoxysilane (TEOS) prior to the addition of the mixture to the tri-block copolymer Pluronic 123 (P123). When 4 g of P123 were used, the molar composition of each mixture was x TEOS: (0.041-x) BTMSPD: 0.24HCl: 8.33H₂O, where x is 0.00125 corresponding to BTMSPD (e.g., 1:3 BTMSPD represents the sample synthesized with a molar ratio of BTMSPD:TEOS=1:3). Removal of surfactant P123 was conducted by an ethanol extraction at 70° C. for 3 days. The solid samples were filtered, washed with ethanol, and dried at room temperature under vacuum.

Reduction of bis(trimethoxysilyl)propyldisulfide functionalized SBA-15 into SBA-SH by PPh₃/H₂O (Overman et al. 1974)

Bis(trimethoxysilyl)propyldisulfide functionalized SBA-15 (500 mg) and excess triphenylphospine (0.78 g, 3 mmol) were dissolved in 15 mL of dioxane and 2 mL of water was added under inert atmosphere. The resulting mixture was stirred at 60° C. for 15 hours. After this time, the solvent was filtered and washed with ethanol and H₂O, and dried under vacuum.

### Example 11

### Scavenging Experiments

100 mg quantities of thiol modified silicates were stirred for 1 hour with 10 mL of Pd(II)acetate or Pd(II) chloride solutions of known concentrations. After this time, the solutions were filtered through a 45 mm/25 mm polytetrafluoroethylene (PTFE) filter and the Pd(II) concentration left in the supernatant liquids was measured by inductively coupled plasma mass spectrometry (ICPMS). Blank experiments on non-functionalized SBA-15 and K-10 Montmorillonite were carried out for 1 hour using 100 mg of support and 10 mL of 0.01 M Pd(II) solutions. Results are shown in Table 1.

### Example 12

### Experimental Procedure for Suzuki-Miyaura Coupling

Aryl halide (1 mmol), phenylboronic acid (1.5 mmol), potassium carbonate (2 mmol), hexamethylbenzene, 0.5 mmol (as internal standard for GC analysis) and palladium catalyst (1%) were mixed in sealed tube. 5 mL solvent (H₂O or DMF or DMF/H₂O mixture (20:1)) were added to this reaction mixture which was stirred at the desired temperature under inert atmosphere. After completion of the reaction (as determined by GC), the catalyst was filtered and the reaction mixture was poured into water. The aqueous phase was extracted with CH₂Cl₂. After drying, the product was purified by column chromatography.

### Example 13

### Experimental Procedure for Mizoroki-Heck Coupling

The aryl halide (1 mmol) was mixed with 1.5 mmol of styrene, 2 mmol sodium acetate and 0.5-1.0% Pd-silicate catalyst in 5 mL of DMF in a sealed tube. After purging with nitrogen, the reaction mixture was heated to 120° C. After completion of the reaction (as determined by GC), the reaction was cooled, the catalyst removed by filtration, and the catalyst was washed with CH₂Cl₂. The inorganic salts were removed by extraction with water and CH₂Cl₂. After drying and concentrating the organic layer, the product was purified by column chromatography on silica gel.

### Example 14

### Heterogeneity Tests

### Procedure for Synthesis of CIPhCONH@SiO₂ and BrPhCONH@SiO₂:

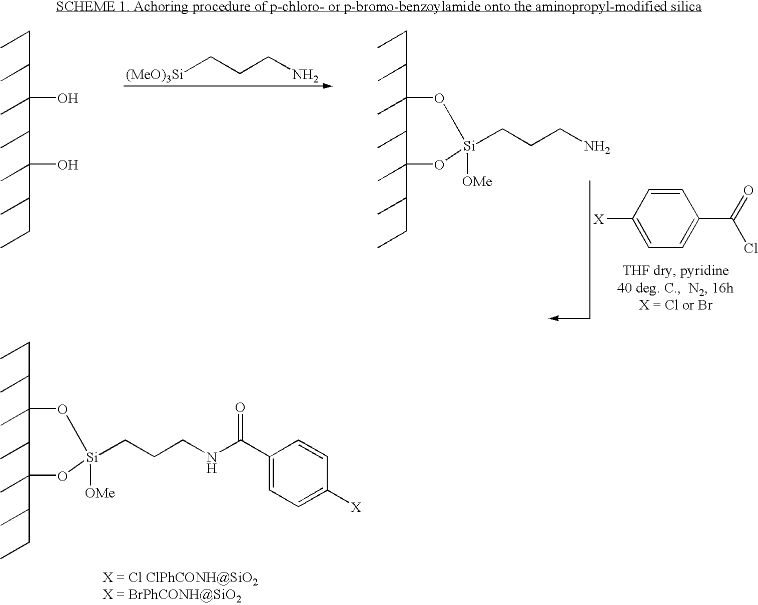

Following the procedure of Baleizão et al. (2004) to prepare silica gel supported substrates, a solution of the corresponding acylchloride (p-chlorobenzoylamide 0.919 g, 5.25 mmol; or p-bromobenzoylamide, 1.15 g, 5.25 mmol) was dissolved in dry THF (10 mL) in a round-bottomed flask along with aminopropyl triethoxysilane-modified silica (1 g, see synthesis below) and pyridine (404 μl, 5 mmol) under nitrogen atmosphere. The resulting suspension was stirred at 40° C. for 12 h, then filtered and washed three times with 20 mL of 5% (v/v) HCl in water, followed by 2 washes with 20 mL of 0.02M aqueous K₂CO₃, 2 washes with distilled water, and 2 washes with 20 mL of ethanol. The resulting solid was washed with a large excess of dichloromethane and dried in air. In the case of BrPhCONH@SiO₂, 1.178 g was recovered, and CIPhCONH@SiO₂, 1.13 g recovered. As used herein, the term “@” is intended to refer to the fact that the ligand is anchored onto the silicate surface, which preferably involves chemical (e.g., covalent) bonding.

### Three-Phase Tests

A solution of 4-chloroacetophenone or 4-bromoacetophenone (0.25 mmol), phenyl boronic acid (0.37 mmol, 1.5 equiv), and K₂CO₃ (0.5 mmol, 2 equiv.) in water was stirred in the presence of SBA-15-SH.Pd catalyst and CIPhCONH@SiO₂ or BrPhCONH@SiO₂ (250 mg) at 100° C. for 24 h in the case of the chloro substrate, or 80° C. for 5 or 13 h in the case of the bromo substrate. After this time, the supernatant was analyzed by GC and the solid was separated by filtration under vacuum while hot, washed with ethanol and further extracted with dichloromethane.

The solid was then hydrolyzed in a 2 M solution of KOH in ethanol/water (1.68 g in 10 mL EtOH, 5 mL H₂O) at 90° C. for 3 days. The resulting solution was neutralized with 10% HCl v/v (9.1 mL), extracted with CH₂Cl₂ followed by ethyl acetate, concentrated and the resulting mixture analyzed by ¹H NMR.

In the reaction of p-bromoacetophenone and BrPhCONH@SiO₂, unreacted p-bromobenzoic acid and p-phenylbenzoic acid (which presumably results from coupling via homogeneous Pd) were observed in a 97:3 ratio after normal reaction conditions (5 h, 80° C.). In addition, 50% of p-phenylacetophenone was observed from coupling of the two soluble reagents, indicating the presence of an active catalyst. Since this was slightly lower conversion than we usually observe at this time (which we attribute to difficulties stirring in the presence of the large amounts of the silica-supported substrate), we repeated the reaction for 13 h. At this time, we observed 97% conversion of the homogeneous reagents, and a 93:7 ratio of p-bromobenzoic acid and p-phenylbenzoic acid.

In the reaction of p-chloroacetophenone and CIPhCONH@SiO₂ in water for 24 h at 100° C., the reaction of the soluble reaction partners went to 80% conversion and no p-phenylbenzoic acid was detected.

### Synthesis of Aminopropyl Modified Silica

3-Aminopropyltrimethoxysilane (APTMS) (16 mL, 90 mmol) and pyridine (10 mL, 123 mmol) were added dropwise to a suspension of SiO₂ (10 g) in dry toluene (30 mL), under N₂ atmosphere. The resulting mixture was refluxed for 24 h. After that time, the suspension was filtered and Soxhlet extracted with dichloromethane for 24 h. The resulting solid was dried under vacuum at room temperature giving 11.8 g of a white powder.

### Hot-Filtration at Various Points During the Reaction

SBA-15-SH.Pd (1 mol %), 4-bromoacetophenone (199 mg, 1 mmol), phenylboronic acid (182 mg, 1.5 mmol), potassium carbonate (276 mg, 2 mmol), hexamethylbenzene (81 mg, 0.5 mmol) as an internal standard and 5 mL of DMF/H₂O (20:1) or pure water, were taken in sealed tube and stirred at 80° C. under inert atmosphere. At this stage, reaction mixture was filtered off at the desired time intervals by using a 45 μm filter at 80° C. and the Pd leaching of the solution was analyzed by ICPMS. Conversion of products were analyzed by gas chromatography and are tabulated below.

In water, we observed the following conversions and leaching at the times indicated:

45 min, 42% conversion, 0.17 ppm

2 h, 62% conversion, 0.17 ppm

It should also be noted that in DMF/water, we did not see any spike in Pd leaching at low conversions:

1 h, 22% conversion, 0.27 ppm

3 h, 56% conversion, 0.34 ppm

8 h, 98% conversion, 0.54 ppm

### Hot-Filtration (Split Test)

SBA-15-SH.Pd (1 mol %), 4-bromoacetophenone (199 mg, 1 mmol), phenyl boronic acid (182 mg, 1.5 mmol), potassium carbonate (276 mg, 2 mmol), hexamethylbenzene (81 mg, 0.5 mmol) as an internal standard and 5 mL of DMF/H₂O (4:1) were mixed in a specially designed Schlenk flask which has a filter in between two separated chambers to permit the reaction to be filtered without exposure to air. The reaction was stirred at 80° C. under an inert atmosphere, and after 1 h (12% conversion), half of the solution was filtered into a separate flask through a Schlenk scintered glass filter at 80° C. Further, both portions were heated for an additional 7 h at 80° C. under inert atmosphere and the products were analyzed by GC. The portion containing the suspended catalyst proceeded to 97% conversion, while the catalyst-free portion reacted only an additional 5% (i.e., total conversion is 17%).

To ensure that there were sufficient reagents present in the solution after filtration, the reaction was performed in 4:1 DMF: water as above, and the flask into which the reaction was filtered was also charged with phenyl boronic acid (20 mg) and potassium carbonate (60 mg). In this case, after 1 h there was 9% conversion, the reaction was split into two, and after 7 h, the silicate containing portion went to 92% conversion and the silicate-free to 14%.

### EQUIVALENTS

Those skilled in the art will recognize equivalents to the embodiments described herein. Such equivalents are within the scope of the invention and are covered by the appended claims.

### REFERENCES

Aoki, K.; Shimada, T.; Hayashi, T. Tetrahedron: Asymm. 2004, 15 1771.
Arvela, R. K.; Leadbeater, N. E.; Sangi, M. S.; Williams, V. A.; Granados, P. Singer, R. D. J. Org. Chem. 2005, 70, 161.
Baleizão, C.; Corma, A.; Garcia, H.; Leyva, A. J. Org. Chem. 2004, 69, 439.
Bedford, R. B.; Cazin, C. S. J.; Hursthouse, M. B.; Light, M. E.; Pike, K. J.; Wimperis, S. J. Organomet Chem. 2001, 633, 173.
Chen, D.; Li, Z.; Yu, C.; Shi, Y.; Zhang, Z.; Tu, B.; Zhao, D. Chem. Mater. 2005, 17, 3228.
Chen, C. Y.; Dagneau, P.; Grabowski, E. J. J.; Oballa, R.; O'Shea, P.; Prasit, P.; Robichaud, J.; Tillyer, R.; Wang, X. J. Org. Chem., 2003, 68, 2633.
Choudary, B. M.; Madhi, S.; Chowdari, N. S.; Kantam, M. L.; Sreedhar, B. J. Amer. Chem. Soc. 2002, 124, 14127.
Davies, I. W.; Matty, L.; Hughes, D. L.; Reider, P. J. J. Am. Chem. Soc. 2001, 123, 10139.
Dufaud, V.; Davis, M. E. J. Am. Chem. Soc. 2003, 125, 9403.
Diederich, F., Stang, P. J., Eds. Metal-catalyzed Cross-coupling Reactions, Wiley-VCH: New York, 1998.
El-Safty, S. A.; Mizukami, F.; Hanaoka, T. J. Mater. Chem. 2005, 15, 2590.
Feng, X.; Fryxell, G. E.; Wang, L.-Q.; Kim, A. Y.; Liu, J.; Kemner K. M. Science 1997, 276, 923.
Garrett, C. E.; Prasad, K. Adv. Synth. Catal. 2004, 346, 889.
Hamza, K.; Abu-Reziq, R.; Avner, D.; Blum, J. Org. Lett., 2004, 6, 925.
Kang, T.; Park, Y.; Park, J. C.; Cho, Y. S., Yi, J. Stud. Surf. Sci. Catal., 2003, 146, 527.
Kang, T.; Park, Y.; Yi, J. Ind. Eng. Chem. Res. 2004, 43, 1478.
Kapoor, M. P.; Inagaki, S.; Ikeda, S.; Kakiuchi, K.; Suda, M.; Shimada, T. J. Amer. Chem. Soc. 2005, 127, 8174.
Sang-Wook Kim, S.-W.; Park, J.; Jang, Y.; Chung, C.; Hwang, S.; Hyeon, T.; Kim, Y. W. Nano Letters, 2003, 3, 1289.
Königsberger, K.; Chen, G.-P.; Wu, R. R.; Girgis, M. J.; Prasad, K.; Repi\check{c}, O.; Blacklock, T. J. Org. Proc. Res. Devel. 2003, 7, 733.
Kuroki, M.; Asefa, T.; Whitnal, W.; Kruk, M.; Yoshina-Ishii, C.; Jaroniec, M.; Ozin, G. A. J. Am. Chem. Soc. 2002, 124, 13886.
Li., L.; Shi, J.-L.; Yan, J. N. Chem. Commun. 2004, 1990.
Lipshutz, B. H.; Tasler, S.; Chrisman, W.; Spliethoff, B; Tesche, B. J. Org. Chem. 2003, 68, 1177.
Littke, A. F.; Fu, G. C. Angew. Chem. Int Ed. 2002, 41, 4176.
Margolese, D.; Melero, J. A.; Christiansen, S. C.; Chmelka, B. F.; Stucky, G. D. Chem. Mater. 2000, 12, 2448.
Mehnert, C. P.; Weaver, D. W.; Ying, J. Y. J. Am. Chem. Soc. 1998, 120, 12289.
Melero, J. A.; Stucky, G. D.; van Grieken, R.; Morales, G. J. Mater. Chem., 2002, 12, 1664.
Mercier, L.; Pinnavaia, T. J. Adv. Mater. 1997, 9, 500.
Nielsen, K. T.; Bechgaard, K.; Krebs, F. C. Macromolecules, 2005, 38, 658.
Nowotny, M.; Hanefeld, U.; van Koningsveld, H.; Maschmeyer, T. Chem. Commun., 2000, 1877.
Overman, L.; Smoot, J.; Overman, J. D. Synthesis 1974, 59.
Pinnavaia, T.; Mercier, L. U.S. Pat. No. 6,465,387, issued Oct. 15, 2002.
Pinnavaia, T.; Mercier, L. U.S. Pat. No. 6,649,083, issued Nov. 18, 2003.
Prashad, M.; Bin, H.; Har, D.; Repic, O.; Blacklock, T. J. Adv. Synth. Catal. 2001, 343, 461.
Rockaboy, C.; Gladysz, J. A. New J. Chem., 2003, 27, 39.
Rosso, V. W.; Lust, D. A.; Bernot, P. J.; Grosso, J. A.; Modi, S. P.; Rusowicz, A.; Sedergran, T. C.; Simpson, J. H.; Srivastava, S. K.; Humora, M. J.; Anderson, N. G. Org. Proc. Res. Devel. 1997, 1, 311.
Sheldon, R. A.; Wallau, M.; Arends, I.W.C.E.; Schuchardt, U. Acc. Chem. Res. 1998, 31, 485.
Shimizu, K.-I.; Koizumi, S.; Hatamachi, T.; Yoshida, H.; Komai, S.; Kodama, T.; Kitayama, Y. J. Catal. 2004, 228, 141.
Wang, Y.; Sauer, D. R. Org. Lett. 2004, 6, 2793.
Wang, X.; Lin, K. S. K.; Chan, J. C. C.; Cheng, S. J. Phys. Chem. B, 2005, 109, 1763.
Zhao, D.; Feng, J.; Huo, Q.; Melosh, N.; Fredrickson, G. H.; Chmelka, B. F.; Stucky, G. D. Science 1998a, 279, 548.
Zhao, D.; Huo, Q.; Feng, J.; Chmelka, B. F.; Stucky, G. D. J. Am. Chem. Soc. 1998b, 120, 6024.
Zhao, F.; Bhanage, B. M.; Shirai, M.; Arai, M. Chem. Eur. J. 2000, 6, 843.

1. A catalyst comprising a functionalized silicate material and a metal, said catalyst prepared by a method comprising:
synthesizing the functionalized silicate material by one-step co-condensation of a silicate precursor and a proportion of a functionalizing agent that is a ligand for the metal;
wherein the silicate precursor is selected from:
(1) SiG₄₋ₐXₐ, where a is an integer from 2 to 4;
G is an organic group selected from:
alkyl having 1 to 20 carbon atoms, which may be straight chain branched, or cyclic, substituted or unsubstituted;
alkenyl having 1 to 20 carbon atoms which may be straight chain, branched, or cyclic, substituted or unsubstituted;
aryl or heteroaryl, which may be substituted or unsubstituted; and
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
X is a group capable of undergoing condensation, selected from alkoxy (OG (where G is defined as above)), halogen, allyl, phosphate, phosphate ester, alkoxycarbonyl, hydroxyj, sulfate, and sulfonato;
(2) a metal silicate selected from sodium ortho silicate, sodium meta silicate, sodium di silicate, and sodium tetra silicate;
(3) a preformed silicate;
(4a) an organic/inorganic composite polymer including a silsesquioxane of general structure E-R″-E, wherein:
E is a polymerizable inorganic silica-based group of the formula SiX₃, where X is defined as above; and
R″ is selected from an aliphatic group of the formula —(CH₂)_{b}— where b is an integer from 1 to 20, which may be linear, branched, or cyclic, substituted or unsubstituted, and an unsaturated aliphatic group of the formula —(CH)_{b}— or —(C)_{b}—, including an aromatic group of the formula —(C₆H₄)_{b}—, which may be substituted or unsubstituted;
(4b) an organic/inorganic composite polymer selected from polyalkylsiloxane and polyaryisiloxane, where the structure of the polymer is —[SiG₂O]_{z}— where G is as defined above and z is an integer from 10 to 200;
(5) a mixture of organic and inorganic polymers, including a composite prepared by co-condensation of an inorganic silica precursor and a silsesequioxane precursor of the formula E-R″-E, or a co-condensation of an inorganic silica precursor and a siloxane terminated organic polymerizable group of the formula X₃Si—R″-Z, where Z is a polymerizable organic group selected from acrylate and styrene and X, E and R″ are defined as above; and
(6) a pre-polymerized silicate based material of general formula SiO₂; and
wherein the functionalizing agent is E-R″-Y, where E and R″ are as defined above and Y is a functional group comprising S, N, O, C, H, P, or a combination thereof;
filtering and drying the functionalized silicate material; and
combining the functionalized silicate material with a mixture of a dry solvent and one or more metals or complexes thereof selected from palladium, platinum, rhodium, iridium, ruthenium, osmium, nickel, cobalt, copper, iron, silver, and gold to obtain the catalyst.

2. The catalyst of claim 1, the method further comprising filtering the combination to obtain the catalyst.

3. The catalyst of claim 1, wherein G is selected from Me, Ph, —(CH₂)₂—, —C₆H₄—, —C₆H₄—C₆H₄—, and a combination thereof, and E is Si(OEt)₃ or Si(OMe)₃.

4. The catalyst of claim 1, wherein the siloxane is of the formula X₃Si—R″—SiX₃, where X is as defined in claim 1 and R″ is a bridging group selected from alkyl and aryl.

5. The catalyst of claim 4, wherein the bridging group is selected from methylene, ethylene, propylene, ethenylene, phenylene, biphenylene, heterocyclyl, biarylene, heteroarylene, polycyclicaromatic hydrocarbon, polycyclic heteroaromatic and heteroaromatic.

6. The catalyst of claim 4, wherein the bridging group is 1,4-phenyl and the silicate is 1,4-disiloxyl benzene.

7. The catalyst of claim 1, wherein the silicate precursor is a silsequioxane.

8. The catalyst of claim 1, wherein the silicate precursor contains hydrolytically stable silicon-carbon bonds.

9. The catalyst of claim 1, wherein the silicate precursor is tetraethoxysilane (TEOS).

10. The catalyst of claim 1, wherein the silicate material comprises a mesoporous silicate material.

11. The catalyst of claim 1, wherein said method further comprises:
adding a structure-directing agent (SDA) during the condensation to introduce porosity to the silicate material; and
removing the SDA before combining the silicate material with the metal.

12. The catalyst of claim 11, wherein the SDA is a porogen and/or a surfactant.

13. The catalyst of claim 11, wherein the SDA is a non-ionic surfactant

14. The catalyst of claim 11, wherein the SDA is a non-ionic surfactant selected from an aliphatic amine, dodecyl amine, and α-, β-, or γ-cyclodextrin.

15. The catalyst of claim 11, wherein the SDA is a non-ionic polymeric surfactant.

16. The catalyst of claim 11, wherein the SDA comprises two or more surfactants

17. The catalyst of claim 11, wherein the SDA comprises an ionic and a non-ionic surfactant, a cationic and a non-ionic surfactant, or an anionic and a non-ionic surfactant.

18. The catalyst of claim 11, wherein the SDA comprises two or more surfactants selected from sodium dodecyl sulfate (SDS), P123, F127, and a Brij-type surfactant.

19. The catalyst of claim 11, wherein the SDA comprises one or more surfactants and a pore expander.

20. The catalyst of claim 11, wherein the SDA comprises SDS and P123.

21. The catalyst of claim 11, wherein the surfactant is a tri-block copolymer.

22. The catalyst of claim 1, wherein said method further comprises providing the metal as a salt, an ionic complex, a non-ionic complex, or a pre-ligated complex.

23. The catalyst of claim 23, wherein said pre-ligated complex is of the general formula LₘM[Y—(CH₂)_{b}—SiX₃]ᵣ₋ₘ, where X is as defined in claim 1, Y is a functional group based on an element selected from S, N, O, C, H, and P, M is the metal, r is the coordination number of the metal, L is a ligand for the metal, m is an integer from 0 to r, and b is an integer from 1 to 20.

24. The catalyst of claim 23, wherein b is an integer from 2 to 4.

25. The catalyst of claim 1, wherein the metal is palladium.

26. The catalyst of claim 1, wherein the functionalizing agent is of the formula X₃₋ₐGₐSi— R″-Y, where R″, G, X, and a are defined as in claim 1 and Y is a functional group comprising S, N, O, C, H, or P, or a combination thereof.

27. The catalyst of claim 26, wherein the functional group Y is selected from SH, NH₂, PO(OH)₂, NHCSNH₂, NHCONH₂, SG, NHG, PG₃, PO(OG)₂, NG₂, SG₂, OG₂, NG₃, imidazole, benzimidazole, thiazole, POCH₂COG, a crown ether, aza, a polyazamacrocycle, a thia macrocycle, and a combination thereof, wherein G is as defined in claim 1 or G is H.

28. The catalyst of claim 27, wherein Y is an aromatic group selected from benzene, naphthalene, anthracene, and pyrene, or an aliphatic group where Y is (—CH₂)_{b}—H, where b is an integer from 1 to 20.

29. The catalyst of claim 1, wherein the functionalizing agent is selected from thiol, disulfide amine, diamine, triamine, imidazole, phosphine, pyridine, thiourea, quinoline, and a combination thereof.

30. The catalyst of claim 1, where the functionalizing agent is a disulfide.

31. The catalyst of claim 1, where the functionalizing agent is the disulfide of 3-mercaptopropyltrimethoxy silane.

32. The catalyst of claim 31, wherein the method further comprises reducing the disulfide bond before absorption of the metal.

33. The catalyst of claim 1, wherein the functionalizing agent concentration is up to 20 mol %.

34. The catalyst of claim 1, wherein the functionalizing agent concentration is up to about 15 mol %.

35. The catalyst of claim 1, wherein the functionalizing agent concentration is about 6 to 8 mol %.

36. The catalyst of claim 1, wherein the functionalizing agent is amine.

37. The catalyst of claim 36, wherein the amine is 3-aminopropyltrimethoxysilane (APTMS).

38. A method of catalyzing a chemical reaction comprising providing to the reaction the catalyst of claim 1.

39. The method of claim 38, wherein the chemical reaction is selected from a coupling reaction, a hydrosilylation reaction, a hydrogenation reaction, and a debenzylation reaction.

40. The method of claim 38, wherein the chemical reaction is a coupling reaction selected from Mizoroki-Heck, Suzuki-Miyaura, Stille, Kumada, Negishi, Sonogashira, Buchwald-Hartwig, and Hiyama.

41. A method of preparing a catalyst comprising a functionalized silicate material and a metal, said method comprising:
synthesizing the functionalized silicate material by one-step co-condensation of a silicate precursor and a proportion of a functionalizing agent that is a ligand for the metal;
wherein the silicate precursor is selected from:
(1) SiG₄₋ₐXₐ, where a is an integer from 2 to 4;
G is an organic group selected from:
alkyl having 1 to 20 carbon atoms, which may be straight chain branched, or cyclic, substituted or unsubstituted;
alkenyl having 1 to 20 carbon atoms which may be straight chain, branched, or cyclic, substituted or unsubstituted;
aryl or heteroaryl, which may be substituted or unsubstituted; and
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
X is a group capable of undergoing condensation, selected from alkoxy (OG (where G is defined as above)), halogen, allyl, phosphate, phosphate ester, alkoxycarbonyl, hydroxyl, sulfate, and sulfonato;
(2) a metal silicate selected from sodium ortho silicate, sodium meta silicate, sodium di silicate, and sodium tetra silicate;
(3) a preformed silicate;
(4a) an organic/inorganic composite polymer including a silsesquioxane of general structure E-R″-E, wherein:
E is a polymerizable inorganic silica-based group of the formula SiX₃, where X is defined as above; and
R″ is selected from an aliphatic group of the formula —(CH₂)_{b}— where b is an integer from 1 to 20, which may be linear, branched, or cyclic, substituted or unsubstituted, and an unsaturated aliphatic group of the formula —(CH)_{b}— or —(C)_{b}—, including an aromatic group of the formula —(C₆H₄)_{b}—, which may be substituted or unsubstituted;
(4b) an organic/inorganic composite polymer selected from polyalkylsiloxane and polyarylsiloxane, where the structure of the polymer is —[SiG₂O]_{z}— where G is as defined above and z is an integer from 10 to 200;
(5) a mixture of organic and inorganic polymers, including a composite prepared by co-condensation of an inorganic silica precursor and a silsesequioxane precursor of the formula E-R″-E, or a co-condensation of an inorganic silica precursor and a siloxane terminated organic polymerizable group of the formula X₃Si—R″-Z, where Z is a polymerizable organic group selected from acrylate and styrene and X, E and R″ are defined as above; and
(6) a pre-polymerized silicate based material of general formula SiO₂; and
wherein the functionalizing agent is E-R″-Y, where E and R″ are as defined above and Y is a functional group comprising S, N, O, C, H, P, or a combination thereof;
filtering and drying the functionalized silicate material; and
combining the functionalized silicate material with a mixture of a dry solvent and one or more metals or complexes thereof selected from palladium, platinum, rhodium, iridium, ruthenium, osmium, nickel, cobalt, copper, iron, silver, and gold to obtain the catalyst.

42. The method of claim 41, further comprising filtering the combination to obtain the catalyst.

43. A method of scavenging one or more metals from a solution, comprising:
providing a scavenger comprising a functionalized silicate material; and
combining the scavenger with the solution such that the one or more metals is captured by the scavenger;
wherein the scavenger is prepared by a method comprising:
synthesizing the functionalized silicate material by one-step co-condensation of a silicate precursor and a proportion of a functionalizing agent that is a ligand for the one or more metals;
wherein the silicate precursor is selected from:
(1) SiG₄₋ₐXₐ, where a is an integer from 2 to 4;
G is an organic group selected from:
alkyl having 1 to 20 carbon atoms, which may be straight chain branched, or cyclic, substituted or unsubstituted;
alkenyl having 1 to 20 carbon atoms which may be straight chain, branched, or cyclic, substituted or unsubstituted;
aryl or heteroaryl, which may be substituted or unsubstituted; and
alkylcarbonyloxy, arylcarbonyloxy, alkoxycarbonyloxy, aryloxycarbonyloxy, alkylcarbonyl, alkoxycarbonyl, alkylthiocarbonyl, phosphonato, phosphinato, heterocyclyl, and esters thereof; and
X is a group capable of undergoing condensation, selected from alkoxy (OG (where G is defined as above)), halogen, allyl, phosphate, phosphate ester, alkoxycarbonyl, hydroxyl, sulfate, and sulfonato;
(2) a metal silicate selected from sodium ortho silicate, sodium meta silicate, sodium di silicate, and sodium tetra silicate;
(3) a preformed silicate;
(4a) an organic/inorganic composite polymer including a silsesquioxane of general structure E-R″-E, wherein:
E is a polymerizable inorganic silica-based group of the formula SiX₃, where X is defined as above; and
R″ is selected from an aliphatic group of the formula —(CH₂)_{b}— where b is an integer from 1 to 20, which may be linear, branched, or cyclic, substituted or unsubstituted, and an unsaturated aliphatic group of the formula —(CH)_{b}— or —(C)_{b}—, including an aromatic group of the formula —(C₆H₄)_{b}—, which may be substituted or unsubstituted;
(4b) an organic/inorganic composite polymer selected from polyalkylsiloxane and polyarylsiloxane, where the structure of the polymer is —[SiG₂O]_{z}— where G is as defined above and z is an integer from 10 to 200;
(5) a mixture of organic and inorganic polymers, including a composite prepared by co-condensation of an inorganic silica precursor and a silsesequioxane precursor of the formula E-R″-E, or a co-condensation of an inorganic silica precursor and a siloxane terminated organic polymerizable group of the formula X₃Si—R″-Z, where Z is a polymerizable organic group selected from acrylate and styrene and X, E and R″ are defined as above; and
(6) a pre-polymerized silicate based material of general formula SiO₂; and
wherein the functionalizing agent is E-R″-Y, where E and R″ are as defined above and Y is a functional group comprising S, N, O, C, H, P, or a combination thereof; and
filtering and drying the functionalized silicate material.
